(19) United States
(12) Patent Application Publication
(10) Pub. No.: US 2013/0218456 A1
(43) Pub. Date: Aug. 22, 2013

(54) WEARABLE TACTILE NAVIGATION SYSTEM

(71) Applicants: JOHN S. ZELEK, Stratford (CA); Marc Hobein, Guelph (CA)

(72) Inventors: JOHN S. ZELEK, Stratford (CA); Marc Hobein, Guelph (CA)

(21) Appl. No.: 13/593,172

(22) Filed: Aug. 23, 2012

Related U.S. Application Data
(63) Continuation-in-part of application No. 11/707,031, filed on Feb. 16, 2007, now abandoned.
(60) Provisional application No. 60/773,642, filed on Feb. 16, 2006.

(51) Int. Cl. G01C 21/00

(52) U.S. Cl. CPC G01C 21/00
USPC 701/412; 701/411

(57) ABSTRACT

The wearable tactile navigation system frees you from requiring to use your eyes as there is no display, all positional information is conveyed via touch. As a compass, the device nudges you towards North. As a GPS navigator, the device orients you towards a landmark (i.e., home) and lets you feel how far away home is. A bluetooth interface provides network capabilities, allowing you to download map landmarks from a cell phone. The bidirectional networking capability generalizes the device to a platform capable of collecting any sensor data as well as providing tactile messages and touch telepresence. The main application of the device is a wayfinding device for people that are blind and for people that suffer from Alzheimer's disease but there are many other applications where it is desirable to provide geographical information in tactile form as opposed to providing it in visual or auditory form.

This application claims the benefit of U.S. Provisional Patent Application No. 60/773,642 and U.S. patent application Ser. No. 11/707,031 filed Feb. 16, 2007.

### FIELD OF THE INVENTION

The invention relates to navigation systems and specifically to navigation systems providing directional and distal information about user position, environment object position and orientation to a user in tactile form.

### BACKGROUND OF THE INVENTION

Physiology: Local properties of mechanoreceptors are understood but not their collective interactions. The modelling of a single mechanoreceptor (including the mechanics of the skin, end organ, creation of a generator potential, the initiation of the action potential and branching of afferent fibres) has recently been studied for single collections in the fingertips [Pawluk, 1997]. This work requires further development into the population responses of neighbourhoods with both excitatory and inhibitory activity. Empirical investigations have provided us with rough estimations on the sizes of the excitatory portion, of the receptive fields for touch on the hand. The receptive field distributions are not unlike the fovea-periphery distinction for visual perception where the touch receptors in the fingertips correspond to the fovea (as shown in FIG. 58). As expected, training also influences the number and size of the receptive fields, i.e., the sensitivity of the hand improves (see as shown in FIG. 59). However, we are not interested in analyzing the fingertip touch receptors.

The tactile unit consists of the primary afferent neurons whose sensors endings respond to light skin deformations and are chiefly located in the dermis (note that other afferent units for joint and muscle receptors may have tactile roles) [Vallbo and Johansson, 1984]. The number of tactile units in one hand number roughly 17,000, supplying the glaborous (non-hairy) skin area. There are two types of tactile fibres Aα (tactile fibres, larger) and Aδ (nociceptive and thermo-sensitive units, smaller). There are basically four types of tactile units, differing by functional properties such as sensitivity to static and dynamic events, size and structure of receptive fields, the numbers, densities and perceptive effects. The four afferent fibre types (PC (Pacinian Corpuscles) or R_{A}AII, RAI, SAII and SAI) are the four basic types. The SAI system plays a primary role in tactual form and roughness perception when the fingers contact a surface directly and for the perception of external events through force distribution across the skin surface. The PC system reacts to the high frequency vibration. The RA system is responsible for the detection and representation of localized movement between skin and a surface. Age reduces the sensitivity, for example, the fingertips of pre-teen individuals contains forty to fifty Meissner corpuslces (NPI, RAI) per square millimeter, whereas by age 50 this has dropped to ten per square millimeter [Sekuler and Blake, 2002]. It was found that intensity JND (just noticeable discrimination) (measured as 20 log^{A+ΔA}, where A is vibration amplitude and ΔA is the amplitude increment) decrease as intensity increases and are roughly independent of frequency and range between 0.4 and 3.5 dB [Tan, 1996]. It is not so clear with regards to frequency discrimination, as frequency JND varies with intensity. Even when intensity cues are removed, the results are not conclusive, but roughly frequency/pitch JNDs increase with frequency over a range of 5 to 512 Hz [Tan, 1996]. With regards to temporal resolution, JNDs increase monotonically from 50 to 150 msec when duration increased from 0.1 to 2.0 seconds. Some experiments have indicated that the time difference between non-fused perception is roughly 10-15 msec, thus providing a rough estimate of a bandwidth that can be conveyed. Explorations on the necessary spatial resolution for duplicating tactile feeling hypothesizes that placing actuators at one half the TPDT (two-point discrimination threshold) is sufficient provided that stimulus presentation to the four types of mechano-receptors is controlled individually [Asamura et al., 2001].

To summarize, there are four mechanoreceptor populations in the glaborous skin of the human hand with FA referring to fast adapting, SA referring to slow adapting, and I and II being the index in each category [Klatzky and S. J. Lederman, 2002]. The receptive field of index I is small and well defined and the receptive field of index II is large and diffuse. The FA mechanoreceptors are fast with no response to sustained stimulation. The SA mechanoreceptors are slow and respond to sustained stimulation. A more detailed and recent characterization of the cutaneous mechanoreceptors is provided by [Gescheider et al., 2004]. There are factors that influence the response of the mechanoreceptors including attention and aging [Craig and Rollman, 1999]. There is also adaptation, in particular, to the disappearance of the sensation of pressure when coincided with an almost constant value of velocity of indentation [Sherrick and Cholewiak, 1986]. There is also some adaptation to vibrotactile stimulation but at a much slower scale. As shown later in the paper, PWM in essence produces amplitude modulation in the applied mechanical signal. The sensitivity to an amplitude modulated vibrotactile stimulus is governed by the tactile temporal threshold which varies from 10 to 50 ms [Weisenberger, 1986]. Thus, in the best case scenario, amplitude modulation can be implemented up to 100 Hz.

Cutaneous Saltation: Rabbit Effect:

Our perception of sensory, stimulation can be biased by the arrival of subsequent events. One such illusion or effect is referred to as cutaneous saltation or the rabbit effect. If a sequence of taps is performed at a regular sample at 3 different locations, lets say with 4 or 5 taps at each spatial location, what is perceived are not 4 or 5 taps at the locations where the force was applied, but rather a uniform distribution of taps is experienced. This refers to the human perceptual system being able to interpolate [Elmer et al., 2005] between impulse locations. In this application, we make use of this pheomenon to present a continuum of information across the body while only stimulating a finite amount of locations.

Vibrotactile Communication:

A vibratory communication system (called Vibratese) was developed in the fifties [Geldard, 1957], where five calibrated vibrators placed on the chest, each varied in three intensity levels (20 to 400 μm) and three durations (0.1, 0.3 and 0.5 sec) at a fixed frequency of vibration of 60 Hz represented a 45 element system consisting of the single letters and digits. Subjects could learn the code in about 12 hours and be able to receive 38 words per minute (a word being five-letters) [Tan, 1996].

Vibrotactile communication in the field of tactile aids for the hearing impaired has a rich history [Summers, 1992]. The devices are used in conjunction with or without a hearing aid and are used to help decipher speech and ambient environmental sounds (e.g., street traffic). The devices use one or more tactors resonating at a fixed frequency, preserving amplitude intensity. Tactors are usually assigned to different parts of the spectrum in terms of the input signal. The Tactaid VII system translates microphone captured audio into a harness with 7 resonant vibrators to be worn on either the forearm, chest, abdomen or neck. A historical review of tactual displays for sensory substitution provided by [Tan and Pentland, 2001] illustrates two major types: (1) pictorial or (2) frequency in place. The Optacon was a finger pin-based system for discriminating quantized tactile representations of text while the Optohapt consisted of 9 vibrators encoding letters of the alphabet. Another sensory substitution device includes the TVSS, a 20 by 20 matrix of solenoid vibrators mounted on a dental chair back conveying camera information.

Vibrotactile displays on parts of the body have been already used to demonstrate a wide range of cognitive augmenting functions for the purpose of improving situational awareness and navigation [Tan and Pentland, 2001], [Tan et al, 2003], balance [Wall et al., 2001], for visualizing medical data [Weissgerber et al., 2004], blind navigational aid [Zelek, 2004] and a 3D spatial orientation awareness [Rupert, 2000]. Vibrotactile displays have been placed on the shoulder [Toney et al., 2003], chest as a vest [Jones et al., 2004], hand as a glove [Zelek, 2004], and waist and chest and other parts of the body including arms and legs [Rupert, 2000], in addition to placing tactile arrays on furniture (i.e., chair) that the body makes contact with [Tan et al., 2003].

Attempts to engage both the tactile and kinesthetic senses [Tan and Pentland, 2001] include the “reverse-typewriter” system, OMAR system, the MIT Morse code display and the Tactuator. The Tactuator consisted of 3 independent, point-contact, one degree-of-freedom actuators interfaced individually with the fingertips of the thumb, index and middle finger providing gross motion to stimulate the kinesthetic and vibrations in the range of 0 to above 300 Hz. Although ideal, these are laboratory instruments and do not lend themselves to wearable and portable implementations.

Tactors:

There are many possible technologies for producing vibrotactile cues—these devices are referred to as tactors—including solenoids (pin arrays), voice coils (speakers), arm linkages and electromagnetic motors (pager motors).

Solenoids are found in the construction of Braille displays [Toney et al., 2003]. Their maximum firing frequency is limited by the mechanical travel of the solenoid slug. To function properly, they rely on a small sharp contact surface with a high degree of contrast. In addition, their power requirements are high. Another alternative is to use mini speakers and some researchers have found them to be effective for vibrotactile stimulation [Murray et al., 2003], [Toney et al., 2003]. One drawback is the audible noise produced as a result of their function. Piezoelectric stimulators have been demonstrated in wearable applications but their required mounting topology and safety issues as a result of their high operational voltages limit their potential use. Electromechanical vibrators such as ones manufactured by Engineering Acoustics (www.eaiinfo.com) have a relatively broad frequency range (200 to 300 Hz) and large intensity range but are somewhat expensive ($250 US) and require significant power, requiring a 1 W (2 V RMS, 0.5 A RMS) driver. Inexpensive DC motors that produce vibration by rotating an eccentric mass [Lindeman and Cutler, 2003], [Toney et al., 2003] are attractive because they deliver significant vibrational force at low voltages in a small robust package and are inexpensive ($1 to $2 US). However, their vibration frequency and intensity are inherently linked. Two types of designs are (1) cylindrical motors which are miniature DC brush motors with a cam shaped counterweight and (2) pancake motors, which encase an eccentric rotor that has some flexibility on its axis of rotation. The pancake motors provide a more radially uniform distribution of vibrational energy whereas the cylindrical motors distribute most of their mechanical energy along the central axis of their cylindrical body [Toney et al., 2003].

One of the motors we have used [Zelek and Holbein, 2005] was a Sanko pager motor (available from Jameco)—standard operating voltage is 3.0 V, the operating voltage range is 2.5 to 3.8 V, and the standard current draw is 45 mA, with the starting current being 50 mA and the minimum starting voltage being approximately 2.0 V. The Sanko motor weights approximately 1.63 g. It spins at approximately 4500 revolutions per minute (75 revolutions per second).

The other motor used was a waterproof encased cylindrical motor, model 6CL-5472A from Vibrator Motor (vibratormotor.com). Its rated voltage is 1.3 V, operating voltage is 1.1 to 1.6 V, rated current is 75 mA and the starting voltage is 0.7 V. The cylindrical motor weighs 2.99 g and its rated speed is 7500 revolutions per minute (125 revolutions per second).

### CROSS-REFERENCE TO RELATED APPLICATIONS

U.S. Provisional Patent Application 60/661,478 entitled “A FPGA Haptics Controller for Controlling Stimulus Parameters of Vibrotactile Tactors in Unconventional modes to produce sustained single and arrays of forces ad other effects in wearable material” is an invention put forward by the same principles as this application. This cross-referenced application pertains to a method of controlling inexpensive vibrating DC (Direct Current) motors (e.g., pager, vibrotactile motors) so as to increase their bandwidth of information provided.

### DESCRIPTION OF PRIOR ART

Heretofore, navigation devices have used GPS (6671618, 6791477, 6502032, 6838998, 7068163,) or compass (6671618, 6320496), have included tactile interfaces (6671618, 6693622). None of the devices previously identified as prior art have specified the unique method we have outlined here for providing the potential of a continuum tactile identification of all possible directions, integrated with the location/position and environment sensing for navigation purposes in a portable, wearable embodiment and have specified a connectivity of the system to the internet.

A few patents mention the use of haptics and sensory substitution including the following:

1. U.S. Pat. No. 6,791,471 (2004)

This application is entitled Communicating position interface between vehicles. “Wireless communication between vehicles may permit position information about one vehicle to be communicated directly to another vehicle. Such an information exchange between vehicles may increase the awareness of an operator of a vehicle to other vehicles in the surrounding environment and may help a vehicle operator operate the vehicle more safely. Vehicles may share through the use of wireless communications position, direction, speed, or other information, such as the deployment of safety devices or the presence of particular types of vehicles (e.g., an emergency vehicle or school bus). The vehicle that receives a wireless communication compares the position, direction, and speed of incoming information from another vehicle to the vehicle's own speed, direction, and position to determine whether action is required.”

2. U.S. Pat. No. 6,671,618 (2002)

This application is entitled Navigation System. “A navigation system comprises at least one tactile actuator. The tactile actuator is adapted to provide tactile navigation stimulus for the user of the system. A controller is provided for controlling the operation of the at least one tactile actuator based on information associated with the position of the user. In operation the position of the user and the direction to which the user should move are determined. The user is then guided by means of the tactile navigation stimulus. The navigation system may be implemented as a portable navigator apparatus that comprises at least one tactile actuator and a controller. The portable navigation apparatus may also comprise means for determining information associated with the position of the user.”

3. U.S. Pat. No. 6,486,784 (2002)

This application is entitled Process and system enabling the blind of partially sighted to find their bearings and their way in an unknown environment. “The invention concerns a method and a system enabling the blind and the partially sighted to direct themselves and find their way in unknown surroundings. Said method consists in teletraining using a portable sensor in particular touch-sensitive or audio, the blind or partially sighted person about the path he must follow to move from one point to another, avoiding obstacles. Said method enables the blind or partially sighted person, having no material landmark which he could remember and recognize by feeling his way with his walking stick, to find his way particularly in streets of a town, in the corridors of an underground railway or of a building.”

4. U.S. Pat. No. 6,791,477 (2004)

This application is entitled Method and apparatus for identifying waypoints and providing keyless remote. “A locator device includes a pocket-sized casing that contains a keyless remote entry circuit for remotely operating a vehicle security system. A GPS receiver circuit is located in the easing and automatically identifies a vehicle waypoint whenever the vehicle is turned off. The locator device then determines from any current location and with a single button press the direction and/or distance back to the vehicle waypoint. Many other novel applications are also performed by the locator device.”

3. U.S.. Pat. No. 6,502,032 (200)

This application is entitled GPS urban navigation for the blind. “A global positioning system that actively guides blind pedestrians and military/police forces. This system uses DoD Global Positioning System (GPS) to provide user position and navigation to centimeter accuracy. Present position and navigation requests are digitally cellular telephoned to a central “base station” where data is correlated with a computerized map database which holds names and coordinates of specific locations, such as streets; intersections; traffic lights; hospitals; bathrooms; public telephones; and internal layouts of major buildings and facilities, in selected regions, cities, and neighborhoods. System operates by user entering desired destination into hand-held unit via voice recognition software or using Braille keyboard. Hand-held unit then transmits present position (PP) GPS satellite signals and desired destination to a base station which contains map database and surveyor quality GPS computer system.”

6. U.S. Pat. No. 6,774,788 (2004)

This application is entitled Navigation Device for the visually impaired. “A handheld navigation device for use by the visually impaired having a camera electrically connected to a microprocessor. The microprocessor is capable of object and character recognition and translation into Braille. A Braille display is electrically connected to the microprocessor. A speaker is electrically connected to the microprocessor for audibly communicating common objects and distances and character recognition translations to the user.”

7. U.S. Pat. No. 6,320,496 (2001)

This application is entitled Systems and methods providing tactile guidance using sensory supplementation. “A tactile guidance system and method provides a user with navigational assistance through continuous background communication. This continuous background communication is realized through tactile cueing. By making the direction giving through tactile cues, a user's main attention can focus on visual and auditory cues in the real world, instead of focusing on the direction giving device itself. An electronic compass maintains the orientation of a user. A navigation state is maintained as a combination of orientation, location and destination. A guidance server provides a mapping from a user's current location to directions to a desired destination. Communication links maintain communication between the tactile direction device and the guidance server. The compass, tactile direction device, communication links and guidance server all interact to provide direction information to a user via a tactile surface. The tactile direction device is small enough to be hand-held or incorporated.”

8. U.S. Pat. No. 6,987,512 (2006)

This application is entitled 3D navigation techniques. “A system and method is provided for facilitating navigation techniques in a three-dimensional virtual environment. The present invention couples input driving techniques to the state of one or more workspace variables (e.g., object state, virtual body state, environment state) to change the user's viewing context within a single input control motion. Modification of the user's viewing context allows navigation to various positions and orientations with out the need to be provided with that viewing context prior to navigation. The modification of the user's viewing context also allows for single input motion employing the same input drive controls.”

9. U.S. Pat. No. 6,838,998 (2005)

This application is entitled Multi-user global position tracking system and method. “A system and method is provided for facilitating navigation techniques in a three-dimensional virtual environment. The present invention couples input driving techniques to the state of one or more workspace variables (e.g., object state, virtual body state, environment state) to change the user's viewing context within a single input control motion. Modification of the user's viewing context allows navigation to various positions and orientations with out the need to be provided with that viewing context prior to navigation. The modification of the user's viewing context also allows for single input motion employing the same input drive controls.”

10. U.S. Pat. No. 7,068,163 (2006)

This application is entitled Method and apparatus for identifying waypoints using a handheld locator device. “A locator device includes a pocket-sized casing that contains a keyless remote entry circuit for remotely operating a vehicle security system. A GPS receiver circuit is located in the casing and automatically identifies a vehicle waypoint whenever the vehicle is turned off. The locator device then determines from any current location and with a single button press the direction and/or distance back to the vehicle waypoint. Many other novel applications are also performed by the locator device.”

11. U.S. Pat. No. 6,693,622 (2004)

This application is entitled Vibrotactile haptic feedback devices. “Method and apparatus for controlling magnitude and frequency of vibrotactile sensations for haptic feedback devices. A haptic feedback device, such as a gamepad controller, mouse, remote control etc., includes a housing grasped by the user, an actuator coupled to the housing, and a mass. In some embodiments, the mass can be oscillated by the actuator and a coupling between the actuator and the mass or between the mass and the housing has a compliance that can be varied. Varying the compliance allows vibrotactile sensations having different magnitudes for a given drive signal to be output to the user grasping the housing. In other embodiments, the actuator is a rotary actuator and the mass is an eccentric mass rotatable by the actuator about an axis of rotation. The eccentric mass has an eccentricity that can be varied relative to the axis of rotation while the mass is rotating. Varying the eccentricity allows vibrotactile sensations having different magnitudes for a given drive.”

Our uniqueness in our invention is still evident over prior art that was not ever patented but related to our work. In addition, there have been many instances of applications in the past that have represented compass information as a belt or provided gps information or compass information as an orientation and or wayfinding aid for people who are blind [Nagel et al., 2005], [Rukzio et al., 2005], [Tsukada and Yasumura, 2004], [Goodman et al., 2005], [Bosman, 2003], [Erp, 2005]. What distinguishes our work is taking advantage of the saltation effect to provide a continuum as well as combining compass, gps information as input to provide landmark referencing and presenting this information via a haptic belt.

We are not the first to propose or develop a tactile belt or wearable technology that provides spatial information. As can be seen from the patents, none of the other patents fully integrated all the functionality and method of presentation that our tactile belt does. However, we are the first to present a viable technology that is affordable, wearable, portable, modular as well as incorporating a novel method for presenting tactile information that capitalizes on the unique abilities of how the human brain processes tactile information. Other relevant literature that was never patented includes the following:

Wendy Strobel, Jennifer Fossa, Carly Panchura, Katie Beaver, and Janelle Westbrook (2004). (University of Buffalo, Center for Assistive Technology,
http://cosmost.ot.buffalo.edu/T2RERC), The Industry Profile on Visual Impairment. A comprehensive profile on the visual impairment marketplace.

Roger Cholewiak, Angus Rupert. (2006). Tactile Situation Awareness System.
http://www.namrl.navy.mil/TSAS/achievements.html,
http://tactileresearch.org/reholewi/TRLProjects.html, NAMRL (Naval Aerospace Medical Research Laboratory, Florida, USA). A vibrotactile vest was developed and tested on navy pilots during the years from the early 1990s to 2006. Up/down and target location was encoded by vibrating motors that the pilot wore. The US Navy loses 10 jets per year, chiefly due to spatial disorientation of the pilot. In 2003, this vest was tested by the NRC aerospace Research (NRC IAR) and Defence R&D Canada (DRDC Toronto). The project was a success but the Navy stopped the project in 2006 due to cost over-runs.

Bob Cheung (2004). The Resurgence of Tactile Display Technologies, Aviation, Space & Environmental Medicine, vol. 75, No. 10, Oct., pp. 925-926, Position, motion cues during flight, communication amongst soldiers, orientation for vestibular patients or elderly, divers in undersea explorations, UAV (unmanned aerial vehicles), astronauts during extra-vehicular activities are just some of the applications where tactile displays can be used. The tactile channel is not a replacement but a supplement to vision, when visual and auditory sensory channels are unavailable, disabled or overloaded in multi-environment applications. Tactile Sight has been in discussions with Dr. Cheung about developing tactile technology for spatial orientation for his research efforts.

Jan B. F. Van Erp, Hendrick A. H. C. Van Veen, Chris Jansen, Trevor Dobbins, (2005), Waypoint Naivgation with a Vibrotactile Waist Belt, AMC Transactions on Applied Perception, Vol. 2, No. 2, April, pp. 106-117. This Dutch group is part of the TNO Human Factors in the Netherlands. They have tested the feasibility of presenting navigational information in a tactile display. The direction is based on location and was shown to be an effective coding. The encoding of distance via vibration rhythm was found to not improve performance. There were 2 studies using helicopter and fast boat navigation. A compass and GPS was used as input and the directional information was fixed to 8 motor locations, separated by 45 degrees. They have also studies a SUIT application for tactile orientation cuing for astronauts.

Koji Tsukada, Michiaki Yosumura, (2004), Active Belt: Belt-type wearable tactile display for directional information, Proc. Of UbiComp 2004, Springer LNCS3205, pp. 384-399. A belt was developed by this Japanese group using 8 motors and a geomagnetic sensor as well as a GPS. An user enters a destination GPS coordinate using an external interface. Distance was also encoded but no benefit was observed. Potential applications suggested include human navigation, location awareness information services, lost properties, entertainment. Appears to be an academic project that did not progress beyond this.
http://mobiquitous.com/activebelt-e.htm

http://der-mo.net/feelspace. An academic group from Norway that studied the long term stimulation with orientation via vibrotactile input. They hypothesized and showed that the individual was able to cognitively sense direction and perception of vibrations on the belt were not the dominant perception.

Ted Kruger (2004), Synthetic Senses, Leonardo, vol. 37, No. 4, pp. 322-323, MIT Press. A MIT researcher that used a tactile belt to investigate the tactile input of magnetic field perception in space experiments. He demonstrated that a magnetomer can sense large-scale magnetic fields surrounding electric motors of a commuter train and flux of current feeding them, thus concluding that magnetomers not only able to sense earths gravitional field but also human physical phenomenon.

http://ambafrance-ca.org/hyperlab/actualite/archive-us/us-commtactile.htm. Research at the STAPS (Physical and Sports Activity), UFR (Training and Research dept) at the Caen University in France, investigating the development of a tactile compass for operational commandos on a military mission.

Martin Elmer, Bettina Forster, Jonas Vibell (2005), Cutaneous saltation with and across arms: a new measure of the saltation illusion in somatosensation, Perception & Psychophysics, 67(3), pp. 458-468. Strong evidence that saltation effect is really the primary somatosensory cortex ability to interpolate between tactile sensations.

Pamela J. Hopp-Levine, C. A. P. Smith, Benjamin A. Clegg, Eric D. Heggestad (2006), Tactile Interruption management: tactile cues as task switching reminders, Cogn. Techn. Work, 8: 137-145. Tactile cues are effective mans for simplifying work tasks associated with remembering.

### SUMMARY OF THE INVENTION

Accordingly, objects of our invention include the following:

Our wearable tactile navigation system overcomes the exponential challenges of haptic navigation. The system consists of a digital compass, accelerometer, BPS positioning unit, bluetooth communications module, memory card, integrated rechargeable battery system, USB connectivity for firmware and user data updates and an optional character display. The accelerometer is used to provide tilt compensation to the compass and identify environmental features by detecting features in the signal that signify the gait required to move around the obstacles. An additional feature is the possibility to include a camera system.

Our wearable tactile navigation system is solely reliant on the tactile modality for providing all navigational information to move around in our world.

Our wearable tactile navigation system has a unique method for providing a continuum of directional information capitalizing on the human tactile perceptual system. Other systems have only provided discrete location points, where the amount of information or points was dictated by the number of motors available. We only use 4 motors to provide 360 degrees of tactile information.

Our wearable tactile navigation system interfaces to the internet via a wireless channel that connects to a cell phone or PDA (Personal Digital Assistant). Our device can make use of our positional sensors such as GPS on the mobile device. Caretakers can also be notified of the position of their patients.

Our wearable tactile navigation system provides an affordable, wearable, portable solution for navigation for people who are blind or people who suffer from Alzheimer's.

Further objects and advantages of our invention will become apparent from a consideration of the drawings and ensuing description thereof.

### DESCRIPTION OF THE DRAWINGS

The invention will now be described in more detail, by way of example only, with reference to the accompanying drawings.

FIG. 1 illustrates one mode of operation of the controller. The controller fuses the sensor information to provide a geographical (in terms of longitude, latitude and altitude) absolute position and position relative to a pre-defined landmark. A distance motor encodes in tactile form, the distance to the landmark. If the direction to the landmark aligns with one of the cardinal directions, then only a single directional motor is activated.

FIG. 2 illustrates another mode of operation of the controller. The controller fuses the sensor information to provide a geographical (in terms of longitude, latitude and altitude) absolute position and position relative to a pre-defined landmark. A distance motor encodes in tactile form, the distance to the landmark. If the direction to the landmark falls between 2 cardinal directions, then those 2 cardinal motors are activated in such a fashion that the human user correctly interpolates and identifies the direction at the analogous (to the real world) position between those 2 cardinal directions.

FIG. 3 illustrates one embodiment of the wearable tactile navigation system. A belt contains the 3 directional motors at the cardinal locations. The controller can be embedded on the belt or disengaged as shown on the chest. The distance motor is placed somewhere else on the body so that it does not align with the directional motors (shown on the chest). The user's cell phone (shown on arm) wirelessly communicates with the system controller.

FIG. 4 illustrates the motor alignment on the belt when it is laid flat. It is assumed that the left and right sides connect when worn to form a circle. The diagram can also be interpreted as conceptual where the belt is a general band that can be worn on the writs, head, chest to name a few but incomplete placements on the human body of the user.

FIG. 5 is a detailed conceptual drawing of the controller. The internal battery sup-plies power to the GPS receiver, digital compass, inertial sensor microprocessor, bluetooth wireless interface and motor drivers. The sensors (GPS, compass, inertial) provide geographical information to the microprocessor which decides what motor(s) to activate and how to activate them.

FIG. 6 is a system drawing of the system of an embodiment of the present invention.

FIG. 7 is a system drawing of the system of an embodiment of the present invention, showing in particular the server, belt and monitor components of the system.

FIG. 8 is a system drawing of the system of an embodiment of the present invention, showing in particular the monitor and control interface component of the system.

FIG. 9 is a drawing of an embodiment of the present invention and the controller that is attachable thereto.

FIG. 10 is a drawing of an embodiment of the present invention incorporating an access hole for connections.

FIG. 11 is a drawing of an embodiment of the present invention incorporating a belt/pouch cut away.

FIG. 12 is a drawing of an embodiment of the present invention showing in particular the adjustable elements of the invention.

FIG. 13 is a drawing of an embodiment of the present invention wherein an actuator is contained in a pouch in the belt.

FIG. 14 shows an embodiment of the present invention formed of multiple layers.

FIG. 15 shows an embodiment of the present invention wherein the actuator is contained within the layers forming the belt.

FIG. 16 is a drawing of an embodiment of the present invention incorporating a heart rate monitor.

FIG. 17 shows an embodiment of the present invention incorporating a pouch for holding a controller.

FIG. 18 shows an exploded view of an embodiment of the present invention.

FIG. 19 is a system drawing of an embodiment of the present invention incorporating a web portal, smart phone application and controller board external to a server.

FIG. 20 shows an example of a user interface webpage available on a web portal of an embodiment of the present invention.

FIG. 21 shows an example of a user interface webpage available on a web portal of an embodiment of the present invention that provides route information in a map view format.

FIG. 22 shows an example of a user interface webpage available on a web portal of an embodiment of the present invention that provides an alert pertaining to a user.

FIG. 23 shows an example of a user interface webpage available on a web portal of an embodiment of the present invention that provides webpage options.

FIG. 24 shows an example of a user interface webpage available on a web portal of an embodiment of the present invention that provides multiple user information access.

FIG. 25 shows an example of a user interface webpage available on a web portal of an embodiment of the present invention that provides information pertaining to a user.

FIG. 26 shows an example of a user interface webpage available on a web portal of an embodiment of the present invention that provides route information in a map view format and shows the location of a user on the route.

FIG. 27 shows an example of a user interface webpage available on a web portal of an embodiment of the present invention that provides route information in a map view format and shows the location of a user on the route and waypoints on the route.

FIG. 28 shows an example of actuator images that may appear in a webpage in an embodiment of the present invention.

FIG. 29 shows an example of a controller of an embodiment of the present invention.

FIG. 30 shows back view of a user wearing a belt of an embodiment of the present invention.

FIG. 31 shows side view of a user wearing a belt of an embodiment of the present invention.

FIG. 32 shows front view of a user wearing a belt of an embodiment of the present invention.

FIG. 33 shows views of a control unit of an embodiment of the present invention.

FIG. 34 shows a cut-away view of a belt of an embodiment of the present invention.

FIG. 35 shows front view of a user wearing a belt of an embodiment of the present invention.

FIG. 36 shows close-up view of a user wearing a belt of an embodiment of the present invention.

FIG. 37 shows a view of a tactile sight logo as appears on an embodiment of the present invention.

FIG. 38 shows views of a control unit and attachment methods therefore, and an interface of an embodiment of the present invention.

FIG. 39 shows actuator pockets and vibration motors of an embodiment of the present invention.

FIG. 40 shows a soft buckle cinch concept and elastic tightening from back view of an embodiment of the present invention.

FIG. 41 shows view of wearable navigation systems and monitors that are embodiments of the present invention.

FIG. 42 shows a view of a tactile sight logo as appears on an embodiment of the present invention.

FIG. 43 shows advantages of utilization of an embodiment of the present invention.

FIG. 44 shows an inside and outside view of the belt of an embodiment of the present invention.

FIG. 45 shows an inside and outside view of the belt with a controller of an embodiment of the present invention.

FIG. 46 shows a side view of an inside and outside of the belt of an embodiment of the present invention.

FIG. 47 shows a view of the belt and the controller pouch design of an embodiment of the present invention.

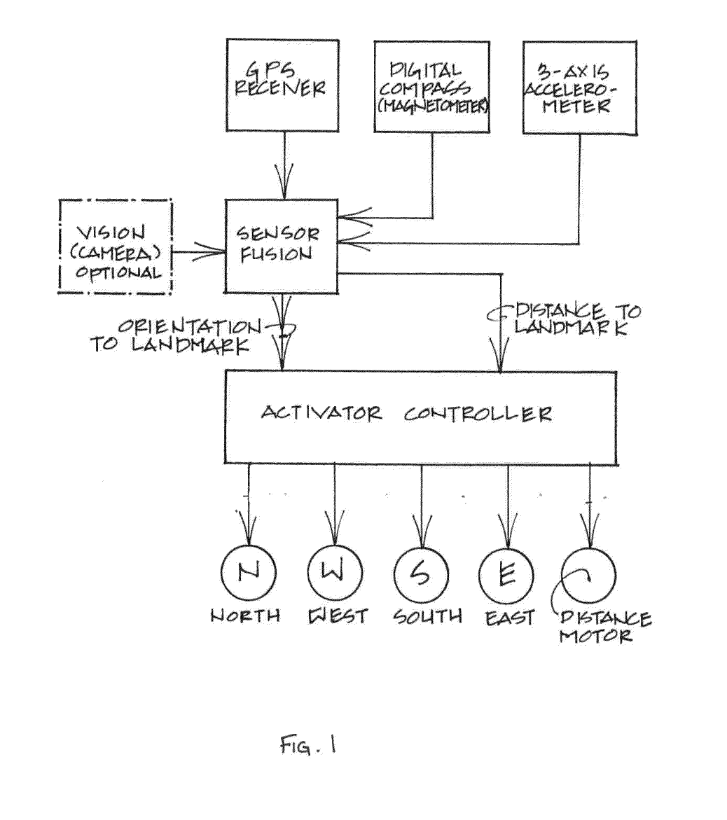

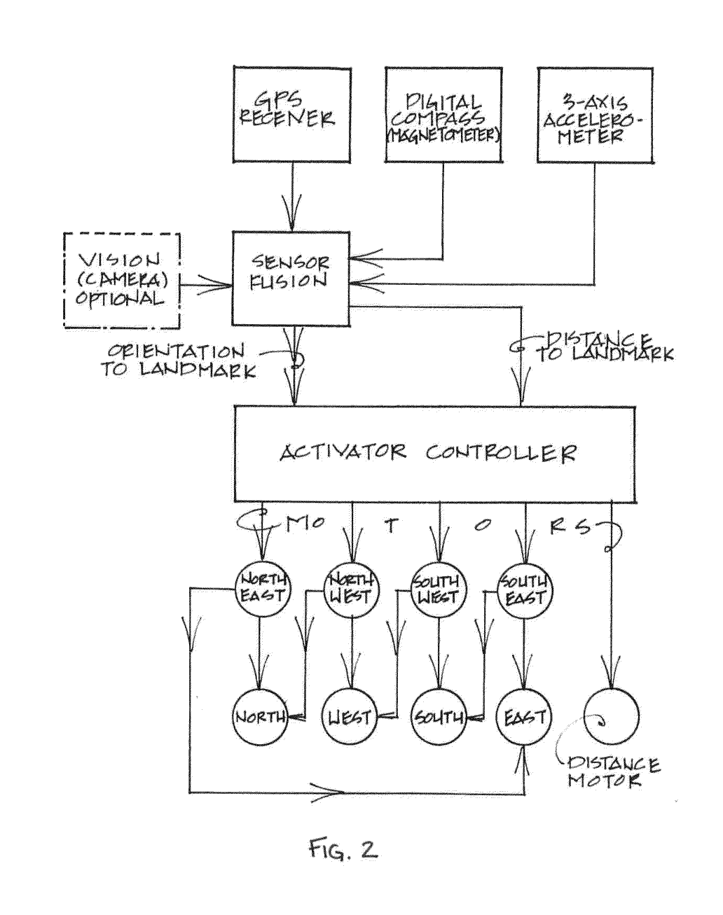

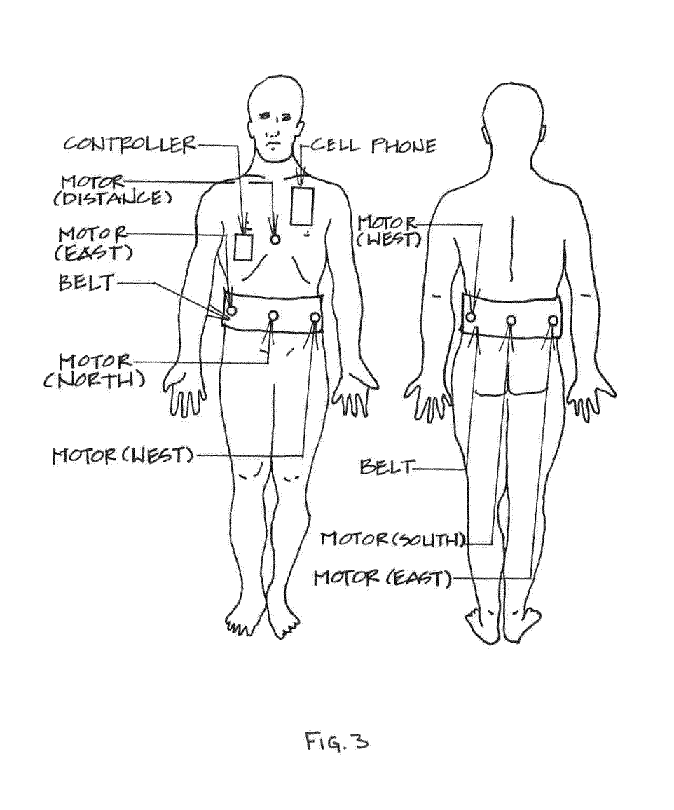

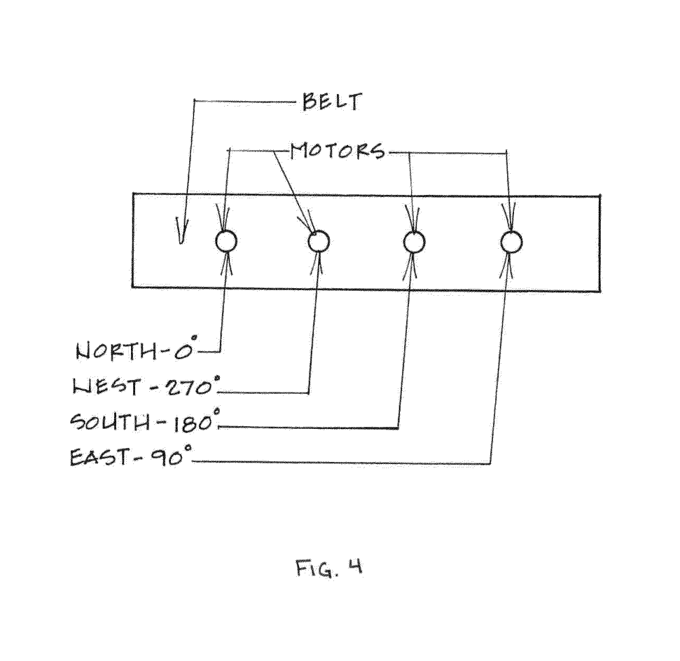

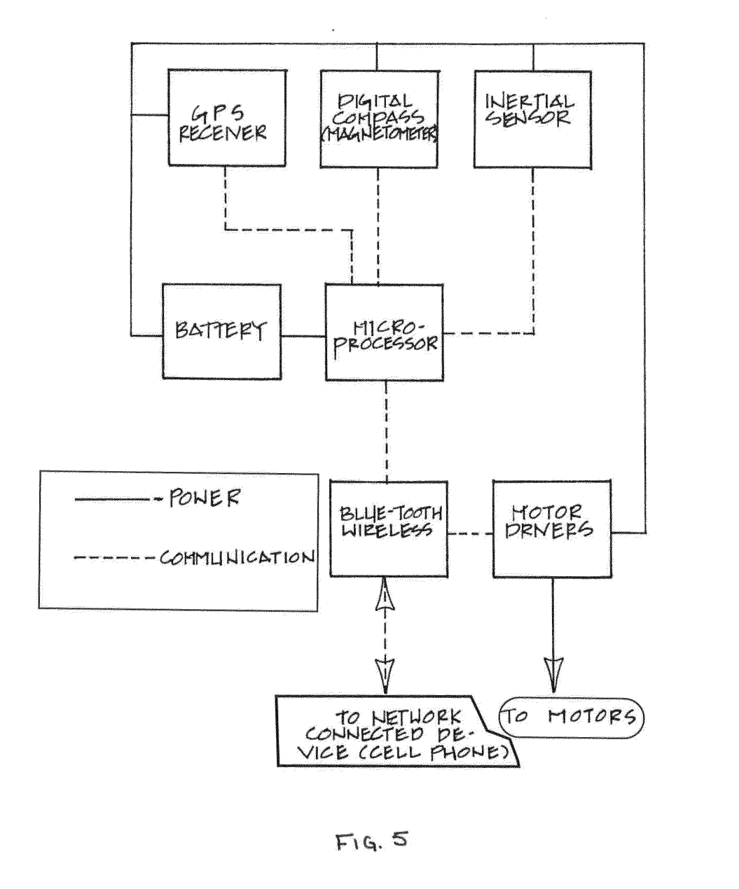

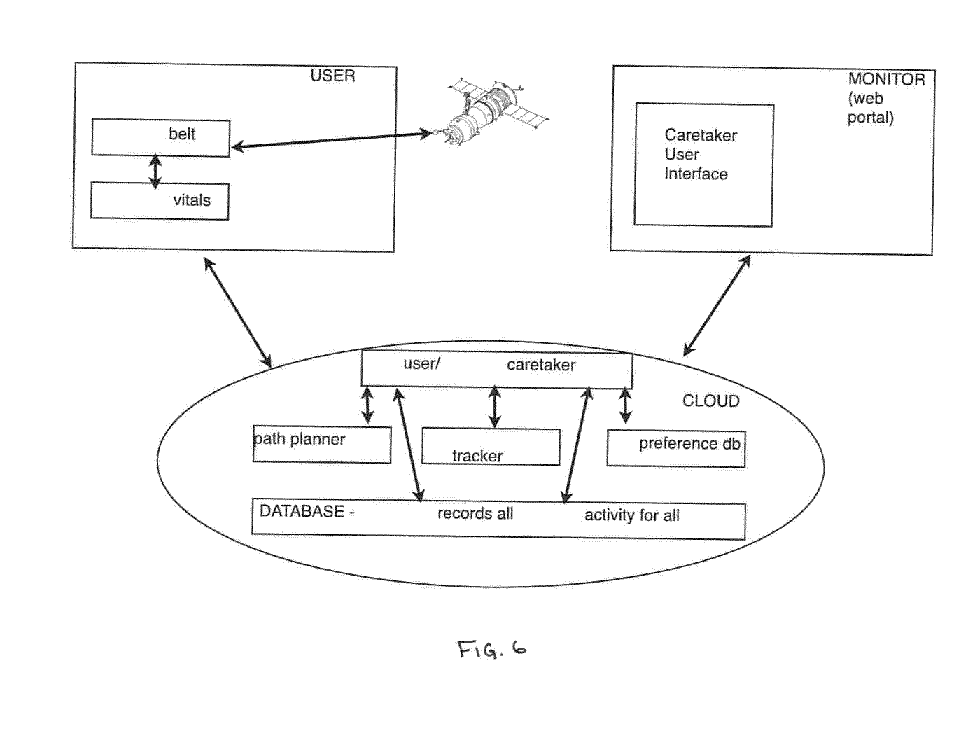

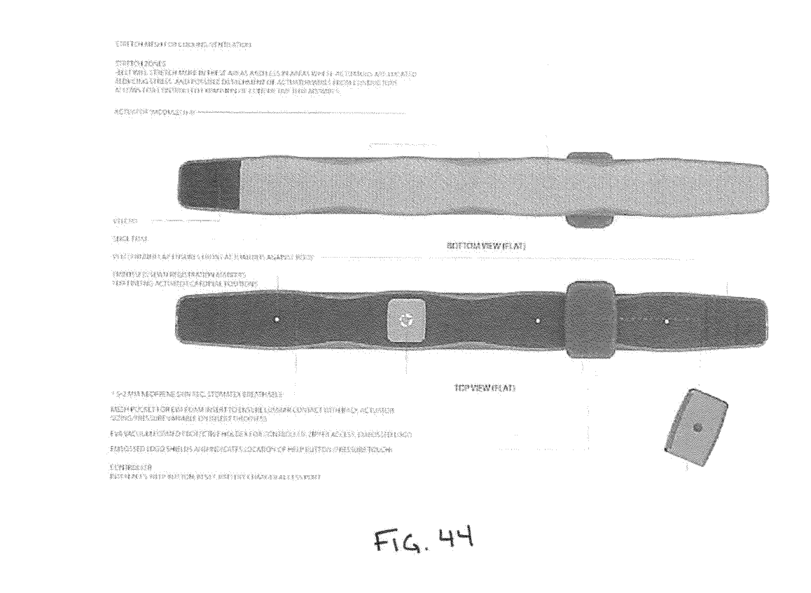

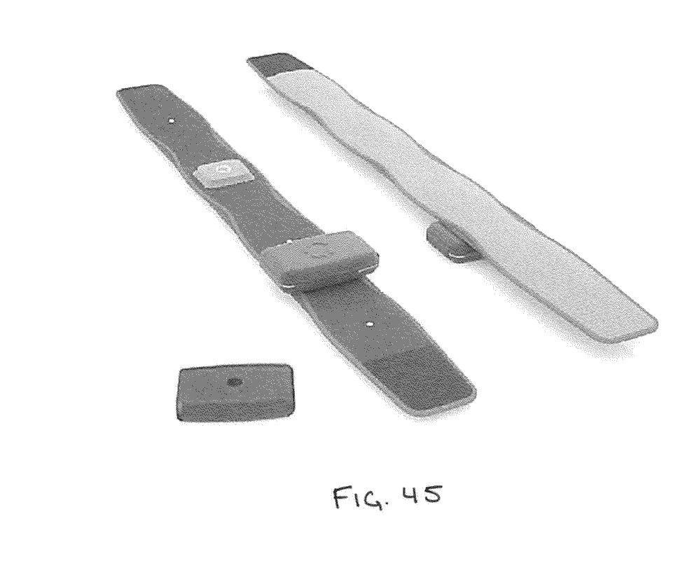

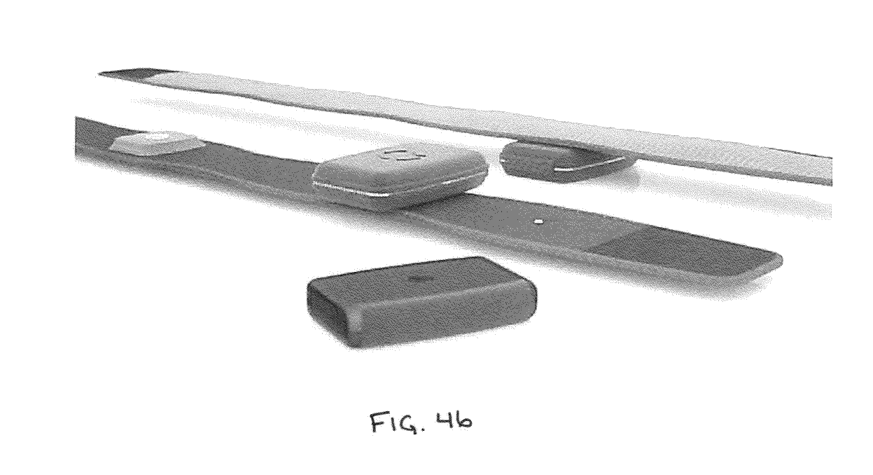

FIG. 44 shows an inside and outside view of the belt of an embodiment of the present invention.

FIG. 48 shows view of the inside face and outside face of the belt of an embodiment of the present invention.

FIG. 49 shows an exploded view of layers of the belt of an embodiment of the present invention.

FIG. 50 shows a top view and a bottom view of the controller unit of an embodiment of the present invention.

FIG. 51 shows an exploded view of layers of the belt of an embodiment of the present invention.

FIG. 52 shows an exploded view of layers of the belt including a layer with conductive stitching thereon of an embodiment of the present invention.

FIG. 53 shows a view of a layer of the belt that is conductive material of an embodiment of the present invention.

FIG. 54 shows a view of a layer of the belt having conductive stitching thereon and wires attached thereto of an embodiment of the present invention.

FIG. 55 shows an inside face view of a layer of the belt having conductive stitching thereon and wires attached thereto of an embodiment of the present invention.

FIG. 56 shows the belt and loose ends of conductive thread of an embodiment of the present invention.

FIG. 57 shows pyralux sewn through a layer of the belt of an embodiment of the present invention.

FIG. 58 shows Receptive Touch Fields of Hands, wherein the receptive field size is shown increasing as the region moves away from the fingertips towards the arms.

FIG. 59 shows Role of Training in Receptive Touch Fields of Hands, wherein with training, the number and size of receptive fields increase in the hand, i.e., the sensitivity of the hand increases.

The figures are described in the previous text.

While the patent invention shall now be described with reference to the preferred embodiments shown in the drawings, it should be understood that the intention is not to limit the invention only to the particular embodiments shown but rather to cover all alterations, modifications and equivalent arrangements possible within the scope of appended claims.

### DETAILED DESCRIPTION OF THE INVENTION

The invention relates to navigation systems and specifically to navigation systems providing directional and distal information about user position and environment object position and orientation to a user only in tactile form. The device is a wearable tactile navigation system. In one role, the device is a wearable compass, worn as a belt around the waist. The device can either use a compass for its bearing or a gps unit, both embedded. A haptic (tactile) belt produces orientation information by vibrating at a particular angle of the belt, indicating magnetic north. The device is to be used as a homing device for people who are blind, who suffer from Alzheimer's, as well as having other commercial uses, such as for hikers and sailors. The entire system also has a GPS and can provide distance information as well as orientation to user defined beacon positions (home). The device can be referred to as a sensory substitution device. The design is innovative in that it capitalizes on the ability of the human tactile system to interpolate between stimulation points. One market is for people who are blind or visually impaired. A person who is blind relies on either a long white cane or guide dog to navigate the world. They are not able to use a conventional compass and cannot locate landmarks unless they can touch them with their long cane. Our device's role is not to replace but rather to augment the use of existing aids. The device provides an orientation and mobility functionality that augments, is non-obtrusive, intuitive, inexpensive, and able to interface with other technology such as a cell phone or i-pod.

Our world is very visual, for example, traffic signs provide direction to only those that can see them. Landmarks (natural or man made) provide direction and help us orient ourselves in the world. The earth's inherent magnetic field provides 2 natural landmarks, the North and South poles. The GPS (Global Positioning System) is a network of satellites that permits a receiver to calculate the precise time and its current position (latitude, longitude, elevation) using trilateration. The human tactile system is typically under utilized for user interfaces and is a natural choice for orientation aids for people who are blind. People who are blind rely heavily on their auditory senses to make sense of the world's ongoings, especially in an urban environment. We have chosen the waist to convey directional information via a belt instantiation (360 degrees around the waist corresponds to potential compass settings). We can alternatively choose any piece of clothing that hugs the body provided that a natural frame of reference orientation system is available. The display of a compass has always been visual, whether in analogue or digital form. Alternatively, we suggest using the human body as an interface to feel magnetic North or a home waypoint. As one instantiation, we make use of the body's inherent frame of reference, correlating the notion of front and back with the poles. A haptic (touch) belt indicates direction by vibrating in the direction of the North pole. In addition, GPS is used to provide an alternative landmark to the North pole. We use only 4 motors and make use of the human perceptual system to interpolate to provide a continuum of potential readings at a resolution only limited by the perceptual system. The device is unique in that it incorporates innovative technology for producing the continuum of directional values using only 4 motors and the device is also affordable, provides independence and improves quality of life, simple and intuitive to use and has other potential verticals in the consumer market, applications including mariner wayfinding, hiking, search and rescue and possibly tourism.

Our device can be labeled as a wearable tactile compass, worn as a belt around the waist. The device can either use a compass for its hearing or a GPS unit, both embedded. A haptic belt produces orientation information by vibrating at a particular angle of the belt, indicating magnetic north. The device is to be used as a homing device for people who are blind as well as having other commercial uses, such as for hikers and sailors. The entire system also has a GPS and can provide distance information as well as orientation to user defined beacon positions (home). The device is a proof of concept demonstrating sensory substitution. The design is innovative in that it capitalizes on the ability of the human tactile system to interpolate between stimulation points. Initial results have been promising. The main market is for people who are blind or visually impaired. A person who is blind relies on either a long white cane or guide dog to navigate the world. They are not able to use a conventional compass and cannot locate landmarks unless they can touch them with their long cane. Our device's role is not to replace but rather to augment the use of existing aids. The initial objectives were to provide an orientation and mobility device that augments, is non-obtrusive, intuitive, inexpensive, and able to interface with other technology such as a cell phone or i-pod.

Currently, our device uses pager motors that are typically used in cell phones but further advances in wearable haptics for tactile communications as well as force and texture replication will increase the bandwidth of the information that can be conveyed by the device described in this application. The increase of bandwidth is not necessary for directional information but will possibly help in the interpolation of direction between two activated actuators on the belt. However, the increase of bandwidth will help in conveying other information such as obstacles, terrain and distal information to landmarks and targets.

Also, we anticipate using a camera as part of the suite of sensors. Computer vision techniques to detect and label objects in the environment, detect context and localize and map simultaneously will further enrich the suite of environmental and positional information that can be conveyed.

The device proposed (and which has already been prototyped, providing a proof of concept) is a complete system that is wearable and self contained in terms of computational capability and power needs. In addition, one way that we achieve connectivity with external devices and the internet is using technology such as Bluetooth.

Our wearable tactile navigation system is (and has been demonstrated to be) a functioning and affordable proof of concept prototype of a wearable device that allows you to navigate using only touch. The device frees you from requiring to use your eyes as there is no display, all information is conveyed via touch. As a compass, the device nudges you towards North. As a GPS navigator, the device orients you towards a landmark (i.e., home) and lets you feel how far away home is. A bluetooth interface provides network capabilities, allowing you to download map landmarks from a cell phone. The bidirectional networking capability generalizes the device to a platform capable of collecting any sensor data as well as providing tactile messages and touch telepresence.

Our innovative method of providing tactile spatial information capitalizes on how the human tactile perception system interpolates sensations to provide detail information. Our innovative engineering design integrates a GPS, 3-axis compass and inertial sensor, power management, battery and embedded processor (for executing our realtime intelligent perception and control algorithms) in a compact and cost-effective package. We plan on capitalize on new technology, for example, new GPS receivers are highly sensitive and can provide positional information to users indoors.

The original application was a way-finding device for the blind. Approx. 4 million (M) Americans have a severe visual impairment (VI) and 8.3 M have some VI. Another Assistive Technology (AT) market is dementia which is estimated at 18 M world-wide. Other markets include the military, tourist, hiker, and search and rescue.

Operation

The physical components of the system include the following:

4 vibro-tactile (haptic, tactile, pager) motors that provide directional information;

1 distal vibro-tactile motor that provides distance information;

a controller consisting of:
1. power management system,
2. battery,
3. OPS receiver,
4. 3-axis accelerometer,
5. digital compass (magnetometer),
6. bluetooth transmitter/receiver, and
7. possibly the inclusion of vision (camera) system in the future.

a material (e.g., neoprene) for the wearable medium that the motors embed on before being worn by the user, so that the vibration and forces exerted by the motor(s) are vertically conducted to the skin and there is minimal lateral conduction of the energy.

Via the bluetooth wireless interface, the system receives a single or a collection of landmarks that are to be used as the current landmark and to be processed in the order provided. Once the person is in the vicinity of the current landmark, the landmark information is removed from the queue to be processed and the next one is labeled as the current landmark.

Other Embodiments

While the above description contains many specificities, these should not be construed as limitations on the scope of the invention, but rather as an exemplification of one preferred embodiment thereof. Many other variations are possible, for example:

The device can take other forms than a belt.

The only constraint is that a continuum of orientations is possible, for example, around the arm, thigh, neck, head.

The device's size is only limited by the electronics.

Communication can be RF, bluetooth, infrared.

The maps and database that the system might reference are best off loaded to another device such as a cell phone of i-pod.

Accordingly, the scope of the invention should be determined not by the embodiment illustrated, but by the appended claims and their legal equivalents.

### CROSS REFERENCE TO DISCLOSURE DOCUMENT

The application was originally submitted as a U.S. provisional patent application on Feb. 16, 2006.

One embodiment of the present invention may be a tactile feedback navigation system comprising: a means for detecting the global orientation of the user; a means for detecting geographic co-ordinate position (in terms of latitude and longitude) of the user; a means for detecting 3-directional accelerations of the user; exactly four tactile actuators, that will provide directional information to a landmark and its inherent coordinate system, placed in the cardinal locations (North (N.), South (S.), West (W.), and East (E.)) aligned on a body part (e.g., waist) upon which we can superimpose a scale system (that defines a circle) that repeats itself from 0 to 359 degrees, i.e., 360 degrees is equivalent to 0 degrees; and each cardinal location is exactly separated by 90 degrees; at least one tactile actuator that provides distal information to a landmark; a wireless communication method to communicate to an internet network via an external device (e.g., computer, cell phone); an integrated power management and portable power source; and a controller that fuses all the on-board and off-board sensors into an optimal accurate estimate of global position in terms of latitude and longitude and possibly attitude and if the sensors provide, the position and size of objects and terrain in the immediate environment.

This embodiment of the present invention may further be a tactile feedback navigation system wherein the entire system is a portable unit and worn by the user.

This embodiment of the present invention may further be a tactile feedback navigation system wherein the entire system is a system that the user makes direct physical contact with.

This embodiment of the present invention may further be a tactile feedback navigation system that acts as a tactile compass where no visual attention or its use is required by the user and information is purely provided in tactile form.

This embodiment of the present invention may further be a tactile feedback navigation system that acts as a GPS (Global Positioning System) where direction to a waypoint is purely provided in tactile form and no use of the visual sense is required by the user.

This embodiment of the present invention may further be a tactile feedback navigation system wherein the controller can be separated into 2 separated components, where one component fuses the positional information that the sensors provide and produces the signal for the actuation of the tactile units and the other component generates the tactile unit(s) actuation signals.

This embodiment of the present invention may further be a tactile feedback navigation system wherein the wireless link can be used to provide a single or procedural sequence of waypoints; the wireless link can be used to provide additional sensor information (GPS, digital compass) from the external device (e.g., cell phone, pda, computer) that connects to the internet network; the wireless link can provide GIS (Geographic Information System) map information that can provide landmarks, obstacles or terrain characteristics; and the wireless link is used to provide positional information about the user to a remote monitor or caretaker.

This embodiment of the present invention may further be a tactile feedback navigation system wherein 4 tactile actuators placed at cardinal locations providing directional information are attached to the body by a piece of clothing that hugs around a body part. The clothing should have the property that it readily transmits the tactile stimuli into the skin and minimizes lateral transmission along the piece of clothing. A material that does this is neoprene but the claim is not limited to neoprene.

This embodiment of the present invention may further be a tactile feedback navigation system wherein the tactile actuating piece of clothing is a belt; wrist band; arm band; head band; leg band; and chest belt.

This embodiment of the present invention may further be a tactile feedback navigation system wherein an additional tactile motor not aligned or in close proximity to the 4 directional tactile actuators is used to provide distal information to the user. The strength of method of stimulating the actuator can be inversely correlated with the distance to the landmark/target. The strength of method of stimulating the actuator can also be proportionally correlated with the distance to the landmark/target.

This embodiment of the present invention may further be a tactile feedback navigation system wherein a queue of waypoints is provided to the controller in order to guide the user in tactile form to a final destination via the intermediate waypoints. An annunciation method can be provided to the user to indicate that the current intermediate waypoint has been reached and a new waypoint is the new current intermediate waypoint. The method of annunciation can either be tactile, auditory or visual. Another annunciation method can be provided to the user to indicate that the final goal destination has been reached. The method of annunciation can either be tactile, auditory or visual.

This embodiment of the present invention may further be a tactile feedback navigation system wherein if the actual direction indicated by the directional device is aligned with any of the cardinal directions (N., S., W., E.) indicated by 0 to 360 degrees and being a multiple of 90, only a single motor corresponding to that cardinal direction is activated and the other 3 directional motors are not activated. 0 degrees is defined as a geographical location which defines a coordinate frame of reference, for example if the modality is of a tactile compass, 0 would define magnetic North. If the desired direction falls between 2 cardinal directions, then the 2 actuators associated with cardinal directions that are closest to that direction are activated in such a fashion that the human body interprets this information as falling between the 2 cardinal positions at an orientation that corresponds to the direction the desired geographical location. The geographical location defining the coordinate frame of reference can be the Earth's magnetic North pole. The geographical location defining the coordinate frame of reference can also be a GPS defined waypoint, also referred to as the home or intermediate home position.

This embodiment of the present invention may further be a tactile feedback navigation system wherein the actuator's intensify of vibration or mechanical force (i.e., amplitude) is the variable controlled; the actuator's frequency of vibration is the variable controlled; the actuator's waveform is the variable controlled; the actuator's pattern of activation is the variable controlled; the actuator's duration of activation is the variable controlled; the actuator's inter-stimulus interval is the variable controlled; or the actuator's inter-activity is the variable controlled.

This embodiment of the present invention may further be a tactile feedback navigation system wherein the method of human tactile perceptual interpolation ability is based on the rabbit effect or also referred to as the cutaneous saltation effect.

This embodiment of the present invention may further be a tactile feedback navigation system wherein the 1 or more tactile actuator providing distal information is related to the actuator(s)' intensity of vibration or mechanical force (i.e., amplitude) as the variable controlled; the actuator(s)' frequency of vibration as the variable controlled; the actuator(s)' waveform as the variable controlled; the actuator(s)' pattern of activation as the variable controlled; the actuator(s)' duration of activation as the variable controlled; the actuator(s)' inter-stimulus interval as the variable controlled; or the actuator(s)' inter-activity as the variable controlled.

This embodiment of the present invention may further be a tactile feedback navigation system wherein the application of interest is wayfinding for people who are blind; or the application of interest is a homing device or localization device for people with Alzheimer's disease or dementia in general. The system can also be used as a tool for tracking of the patient by a caretaker or care facility.

This embodiment of the present invention may further be a tactile feedback navigation system wherein the function of the entire system is to guide the user to landmarks/targets which may be organized as a sequence in queue.

This embodiment of the present invention may further be a tactile feedback navigation system wherein the entire system can function as an obstacle avoidance system, a different mode than the general mode of being directed to a goal.

This embodiment of the present invention may further be a tactile feedback navigation system wherein the entire system can function as a system that can guide the user in a preferred path, or trajectory, whether it be to avoid obstacles as in claim 43 or to maintain a straight line or follow a safe route to avoid injury.

Tactile Wayfinding Belt System

One embodiment of the present invention is a Tactile Wayfinding Belt. This embodiment of the invention is designed to be an affordable, wearable personal navigation device. A user may wear the belt and utilize the belt to navigate (by sensing location via GPS and other sensors) with only touch being applied as the sense that provide guidance to the wearer. Utilizing the device may allow a user to be guided without requiring use of vision, or other senses. Embodiments of the present invention may not include any visual display and all information may be conveyed by the belt via touch.

This embodiment of the present invention functions in a manner that is akin to a version of a mapping application, such as Mapquest™ or Google Maps™, that provides information to a user regarding routes in as touch sensitive information instead of visual information. The device of the present invention nudges a user towards a destination using intermediate waypoints and lets the user feel how much further he or she has to go to reach a pre-determined destination. The way-points provide points of reference to a user, and are utilized by the system to determine the route that the invention will guide a user to follow to reach a pre-determined destination.

For example, a visual map application, such as is available on smart phone, is used by a user to determine a path or route to a predetermined destination. The visual map includes multiple way points along the route. The present invention utilizes such waypoints to define a path. The waypoints are sent to the present invention and the system of the invention works its way through the queue of waypoints to determine route for the user to reach the pre-determined destination. The belt of the present invention functions to guide the user by providing tactile sensations that are interpreted by the user as guidance to move in a particular direction. Thus the belt functions to guide the user in accordance with the route that is established based on the way point, and in this manner a user is guided in appropriate directions towards the pre-determined destination via the waypoints until that final destination is reached by the user.

During the travel, a remote caretaker can access a web portal and information relating to the route that the user is being directed along by the belt, and the progress of the user along that route. The remote caretaker can use this information to monitor the path and progress of the user. The remote caretaker can use facilities and applications available via the web portal to redefine the path and overall route that the user is being guided to follow. In this manner the remote caretaker can adjust or override the route that the system determines to indicate a different route if there is a need for the user to follow a path that differs from the path automatically determined by the system.

The present invention is of particular use and benefit for people with visual impairments (e.g., visually impaired, blind, etc.) or cognitive impairments (e.g., dementia, Alzheimer's, etc.), or for people who are perceptually or cognitively overloaded (e.g., military personnel, first responders, etc.).

For example, the navigation belt of the present invention may empower people with Alzheimer's by providing them with a safe means of travelling from one location to a pre-determined destination.

Embodiments of the present invention require minimal cognitive engagement, provides 2 way tracking, monitor user progress, and guide a user along a route.

Embodiments of the present invention may further incorporate one or more health monitors. In this manner, the present invention may also act as a health gateway by conveying physiological signals. As an example, an embodiment of the present invention that incorporates a health monitor that is an altimeter (measuring height above sea level) may monitor whether a user has fallen. This is beneficial to populations susceptible to falls, such as an elderly population.

In general, the present invention may provide a benefit to people who may otherwise need to rely upon caregivers for mobility or monitoring. Use of the present invention may permit people with disabling conditions to remain at home instead of being required to reside in a nursing home or other institutional environment. Allowing people to continue to live in their own homes during a disabling condition offers a further benefit in that it can reduce national health care costs.

Embodiments of the present invention are designed to be compact, ergonomic, light weight, and to operate for long durations of time (e.g., such as for a full day).

Embodiments of the present invention have been tested over a period of with the Alzheimer demographic. In North America alone there are 14 million legally visually impaired people and 7 million Alzheimer patients, and these numbers are increasing annually. In addition, the number of elderly people in the world is continually increasing as are the disabling conditions that are typically prevalent with aging. The present invention offers a benefit in that it offers some impaired and disabled persons an amount of independence regarding travel between locations.

The present invention offers may benefits and advantages over the prior, including that the present invention provides guidance to users exclusively through touch sensation. Other prior art systems do not function to provide guidance solely based on touch. Guidance solely through touch can provide a user with clearly understood directions. Also, environmental factors, such as noise, sunlight that can make a display screen difficult to see, or other factors cannot interfere with the directions provided by touch sensation. Therefore, the guidance information provided to a user by the present invention is unlikely to be interfered with or diminished in by factors existing in some environments.

Another benefit and advantage of the present invention is that it requires minimal cognitive engagement by a user and use of the invention can improve the quality of life of the user. Other prior art system require a greater level of cognitive engagement and therefore are not useable by as wide of a population or some of the groups of users, for example, such as Alzheimer patients having a diminished level of cognitive engagement, who are able to use the present invention.

Embodiments of the present invention that offer other monitors, such as in a sensor suite (e.g., heart rate monitors, altimeters, etc.) offer further advantages and benefits over the prior art, in that the present invention can guide a user, and can also monitor the welfare of the user. For example, the sensor suite of the present invention can detect certain activities and states of a user, such as when a person falls down. The system can provide alerts as necessary to appropriate parties and/or authorities (such as care workers, family members, police, ambulances, etc.) so that appropriate aid can be provided to the user. Other prior art systems do not offer health and welfare monitoring in relation to directional guidance provided to a user.

Yet another benefit and advantage of the present invention over the prior art is that it provides information to family members, nursing facilities, or other care workers for the user. Such people can obtain information regarding the whereabouts and status of the user, and may also obtain other information relating to the user, such as information regarding where the person lives, appropriate contact names and numbers, etc. This can provide such people with peace-of-mind as the user independently moves about. The information available to such people regarding the user may be provided in real-time, for example, such as real-time monitoring of the progress of a user along a route. The present invention may further provide 2-way real-time tracking of a user. Other prior art systems do not provide these facilities to persons who are not the user.

As still another benefit and advantage over the prior art, use of the present invention can reduce costs incurred by insurance companies, health care systems and physicians, as is described herein. Such costs are not averted by use of prior art systems.

Prior art devices provide perimeter trackers for people with diminished cognitive abilities, for example, such as is caused by Alzheimer's. These prior art devices function to alert authorities if a perimeter has been breached. The present invention functions to allow guided independent movement by a user, so that a user can move between locations on their own as guided by the belt. Therefore, a person navigating solely based on tactile indications on a belt can be guided to a destination without the need for another person with no errors in navigation. Tests of the present invention have shown that even a person with medium to severe Alzheimer's can manage to be guided by the present invention.

Other prior art devices for use by persons who are blind, such as GPS Trekker™, include a GPS system that uses a braille interface for interfacing with its users. This requires people time to stop and input and receive information. The present invention acts almost like a sixth sense in that it almost requires no cognitive engagement. It is therefore easier to use than prior art systems.

Embodiments of the system of the present invention may include several elements, including the following:

Belt

The system of the present invention includes a belt that consists of a controller as well as a physical belt that is worn by a user, generally around the user's waist area. The belt may have one or more actuators embedded therein. The actuators function to indicate direction to a user by vibrating. The person wearing the belt, the user, can feel the vibrations. The belt is a tactile belt that consists of a controller and a wearable tactile belt that includes a communication system as well as a server network for 2-way communication and control.

The GPS utilized by the system may be a highly sensitive precise unit in the order of 30 cm to a metre for single operation accuracy. The GPS can provide localization information in some indoor environments (e.g., single floor dwellings).

The belt may incorporate other sensors, for example, such as: inertial (3 axis accelerometers); digital compass; and altimeter (15 cm accuracy). The altimeter can be used to detect falls which are prevalent amongst the elderly.

Also included in the belt is a small rechargeable power supply and power management system.

The wearable belt is ergonomic, contains actuators connected by stretchable conductors.

Embodiments of the present invention may include four motors. This number of motors in particular preserve battery life.

360 degrees of resolution are obtained by relying on the body's ability to interpolate between sensations and activating neighbouring motors with the appropriate intensity. The touch sensations delivered to the user may vary to provide different types of guidance information, and to provide information with differing levels of urgency. For example, faster or more intense vibrations may indicate greater urgency that a user be guided in a particular direction, such as when a user needs to change direction to keep on the determined route. Vibrations that overlap, or do not overlap so that the vibrations are spaced with intervals of stillness in between may indicate other information to a user. A skilled reader will recognize the variety of vibrations that may be provided to a user. Experiments have shown the salutation effect that may be provided to a user through various types of vibrations, for example, such as are described in Sungjae Hwang and Jung-hee Ryu, “The Haptic Steering Wheel: Vibro-tactile based Navigation for the Driving Environment” 978-1-4244-5328-3/10 (2010) IEEE.

The system of the present invention can save power via intelligent power management. For example, the system may only powering on the belt when the belt is in use, and may powering off the belt when the belt is not in use.

A web portal may be accessed by persons, including family member, caretakers or other appropriate persons, to track the locations of the user. Some people may also be authorized to alter the route or destination of the user on the fly, as described herein.

The components of the belt include the following:
a controller the size of a cell phone which consists of the following integrated components: sensors including a high precision gps, inertial sensors, altimeter, and magnetometer; communications interfaces including bluetooth and GSM (i.e., the unit includes cellular functionality to the cloud) (with a sim card slot, the sim card & data plan is not included); an automatic power management system (system turns on & off automatically upon use) & lithium-ion battery pack; micro-processor, antennas, motor drivers; a usb interface for re-charging the battery as well as a direct data communication link to the unit; a dedicated electrical connector for electrically connecting to the receptor of the belt; and software that runs on the unit and is able to communicate with a central server.
a belt containing: a receptor pouch for the controller including an electrical receptor connection; one or more motors (and in some embodiments 4 motors); and the belt comes in standard sizes, for example, such as Small (approximately 28-30″), Medium (approximately 32-34″), Large (approximately 36-38″), extra-large (approximately 40-42″), and extra-extra-large (approximately 44-46″).
the belt may include vital sign suite that may include monitors such as the following: a heart monitor (ECG) that communicates to the belt controller and can bootstrap to provide this data to the cloud. In addition to a heart monitor, other vitals that can be monitored include EEG, blood pressure, diabetic sugar monitoring, etc. The unique feature is that this data is time and location stamped so that the caretaker (or possibly doctor) has a written record of when the readings occurred, where they occurred and what activity the user was engaged in at the time. The activity is determined by the inertial sensor readings. A skilled reader will recognize the variety of monitors that may be included in, or otherwise incorporated with, the belt and the system of the present invention.

The belt of the present invention can function as both a tracker and a navigation device. As a tracker device the belt can function so that a caretaker or other authorized person can keep track of the user as the user progress along a route. The belt provides information regarding the location of the user and thereby the user's movement is tracked as the location of the user changes. This tracking information may be provided in real time. As a navigation device, the belt provides touch sensation to a user to guide the user to a destination, as described herein.

Other prior art devices, for example, such as the Keruve GPS™ watch, the Actrex GPS™ shoes or the Adiant Solutions S-911™ bracelet, solely function as tracking devices, meaning that a caretaker or supervisor can track the people wearing these devices. These prior art devices do not function as a navigation system.

The present invention further guides a user, via tactile stimulus felt by the user who is wearing the belt, to a chosen destination. The device has been shown in tests to be reflexive in nature, thereby guiding a user to a destination without requiring the user to think about or process the tactile signal. In this manner, the present invention function almost like a sixth sense.

Field trials of embodiments of the present invention have shown that the system and device navigate the wearer in a manner that is more effective than verbal or audio commands. With audio commands, the wearer occasionally made mistakes and environmental factors, such as noise can interfere with the command. Tests show that the wearer does not make navigation errors when utilizing the present invention. Tactile commands are almost reflexive in nature and provide something akin to a sixth sense in the manner whereby they convey information to a user, and the present invention utilizes tactile commands to provide navigational information to a user. The device also has all the infrastructure in place to be utilized as a dynamic health monitoring system that can tag physiological signals with the geo-location as well as the activity of the user. Therefore, the device can be utilized as a mobile medical lab and can be a health tool.

Testing of embodiments of the present invention occurred over a period of 3 years and such tests were conducted by the Toronto Rehab Institute as well as Sunnybrook hospital. The study was funded by the American Alzheimer Association. The tests conducted evaluated how well the participants navigated an obstacle course when presented with tactile navigational signals as compared to verbal signals. The results of the tests shows that tactile commands hardly produced any error whatsoever by the user. The only error produced was when a women with severe Alzheimer's was distracted by a conversation and did not attend to the tactile signals immediately but did attend after a delay. The results were tabulated, evaluated and published in 2 international scientific journals including the following:

Lawrence Grierson and John S. Zelek and Isabel Lam and Sandra E. Black and Heather Carnahan (2011). The Applicability of Vibrotactile Directional Information in Facilitating Navigation for Persons with Dementia, 23(2), pp 108-115, Assistive Technology.

Lawrence Grierson, Heather Carnahan and J. S. Zelek (2009), The Application of a Tactile Wayfinding Belt to Facilitate Navigation in Older Persons, Aging International 34(4), 203-215, Dec.

Furthermore, an efficacy study of an embodiment of the present invention conducted by Baycrest determined that the device is particularly effective for people still living at home, but can also have uses for patients at long term care facilities.

System

An embodiment of the present invention incorporates a computer server as part of the system. For example, a computer server system that exists in the cloud. The server may function to interface the user with the monitor. The monitor is a person, such as a caretaker, family member, or other person authorized to track, monitor or otherwise have access to a user's locational and other information. When the device is not used as an assistive device, it is possible for the person who monitors the user to also be the user.

The server receives location information from the belt as well as other information from the belt including motion information (for example, such as 3D velocity and acceleration information), orientation (for example, such as in geographic grounded coordinate system, North, South, West, East directions, etc.), altitude (for example, such as meters above sea level) as well as vital signs.

Additionally the server can also accept emergency information from the belt, either being initiated by the wearer or initiated by a belt failure. The server keeps track of all the belt users as well as all the monitors. There can be a one to one, many to one, or one to many mapping between monitors and users.

The server may address privacy concerns of the user to monitor mappings. For example, the server may address privacy concerns by maintaining a database whereby relationships and authority provided for people to monitor users is stored and checked by the system before any monitoring access is provided by the system.

The server also consists of a map that accepts destination locations from the monitors and determines the path segments with associated waypoints that are sent to the relevant users.

The server will also re-compute the path if the location of the user deviates from the desired trajectory. This can occur on the fly. If the user chooses to deviate from the chosen trajectory or head in another direction that is not a waypoint, the path is re-computed to direct the user via a new set of intermediate waypoints so as to arrive at the final destination.

The cloud component of embodiments of the present invention may consist of a tracker, path planner and a database of users and their preferences. This component may further include a recording of all paths traversed and associated sensor readings (and possibly accompanying vital signs).

In addition, the cloud server records all activity by all users for the purpose of medical monitoring, permitting doctors to recall vital signs and activity and associate that with location and time. This has the potential to revolutionize how medical assessment is achieved.

In embodiments of the present invention all vital sign measurements are location and time stamped and recorded. What this means is that via the GPS, the location is determined and via the accelerometer we know if the person is moving slowly or quickly and these are associated with a particular time and vital sign measurement. This data pairing when played back will tell the physician where, when and what activity the person was engaged at when a salient vital sign measurement was observed.

Monitoring

The monitoring element of the present invention system is a web portal that may be accessed anywhere in the world on any device such as a mobile phone or computer and is typically used by the person, who is provided authority to monitor the user (as discussed herein, this person may be a caretaker, a family member, or any other person authorized to monitor the location and other information relating to a user). If the device is used as a recreational device, it is quite possible for the monitor to be the same person as the user.

The monitoring element of the present invention may reside on a smart phone, tablet or computer. From this application, the monitor can keep track of the current location of the user and the monitor can also set or re-set the destination for the user. For example, on a mobile device, such as a smart phone, a monitor may activate the web portal and be able to set where a user is to go. The monitor can view the progress of the user along the route in real time, as the progress will be visually displayed on the monitoring element through the portal. The monitoring element may further display certain alerts, for example, such as if the user does not arrive at a destination, or other events occur along the route, such as the user falling down, etc. The belt may further incorporate an emergency button, and if the user is to press the emergency button an alert may show in the monitoring element to show that the user has indicated an emergency situation.

The monitoring element may further be connected to people or institutions and may be operable to contact such people or institutions in particular events. For example, the police may be contacted in upon certain events occurring and be directed to the location of the user, or an ambulance may be contacted, etc. Specified contact persons may also be contacted upon certain events occurring, such as family members or other persons.

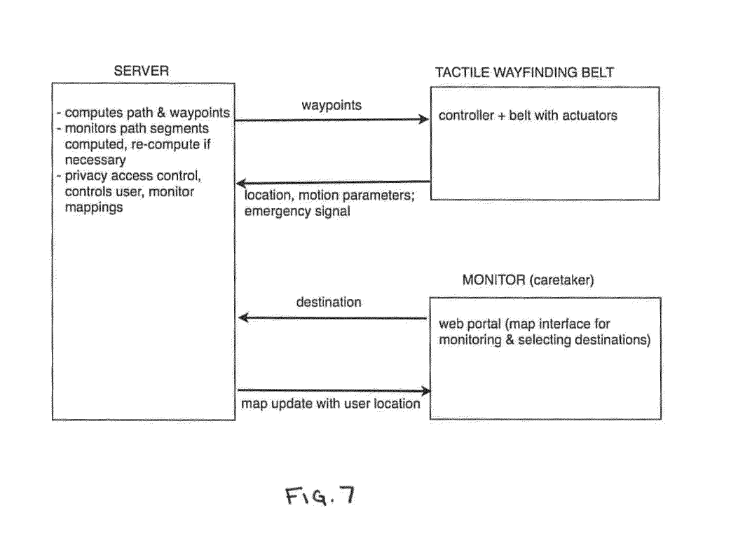

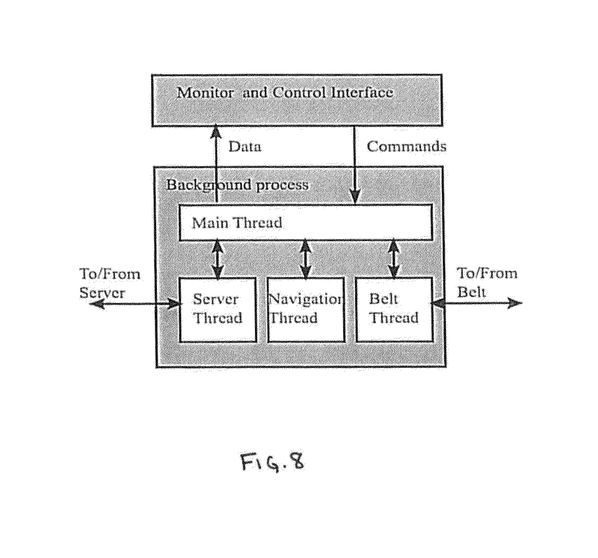

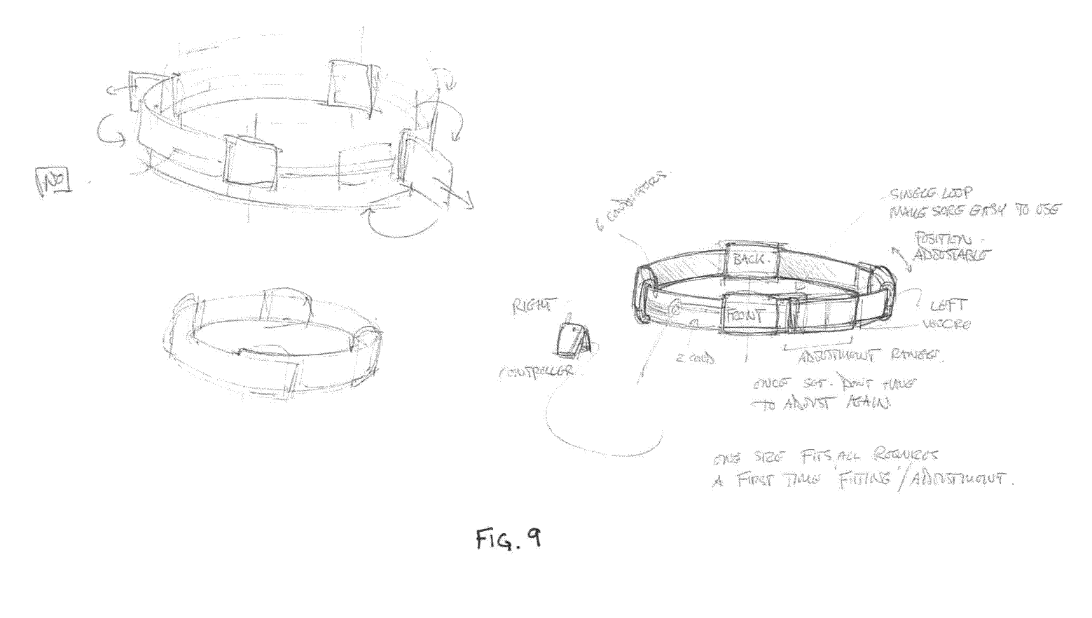

The components of the present invention in embodiments of the present invention are shown in FIGS. 6 and 7. All communications between the components of the system of the present invention may occur via an appropriate connection, for example, such as an ethernet connection, or via wi-fi which can also be over a cellular network or bluetooth.

In one particular embodiment of the present invention the belt is a wearable belt that has actuators (i.e., vibrating motors) embedded at the 4 cardinal locations around the waist; as well as a controller unit that embeds the electronics as well as the communications. The tactile wayfinding belt communicates with the monitor (i.e., caretaker) always via the server. Communications will typically be via the cellular network but may also be wifi or bluetooth initiated. The Tactile Wayfinding belt is just another device on the internet that communicates with the server.

Directional information is conveyed by one of the four motors vibrating. If the front actuator is vibrating then the person is to continue in the forward direction. If the backward motor is vibrating, then the person is to turn around 180 degrees and go in the opposite direction. If one of the side motors is vibrating then the person is to turn in that direction. 4 motors are chosen to minimize the power consumption of the unit as the motors are the most power consuming element as part of this component. Even though 4 motors are used to indicate the cardinal locations, that being 0, 90, 180, and 270 degrees; we utilize the human perceptual property of saltation to convey all possible directions. Saltation is the human perceptual system phenomenon that allows a person to interpolate between tactile sensations. Saltation refers to where mis-localization occurs for two successive and spatially separated tactile stimuli. Saltations can be found over the whole body, but never appear to cross the body midline. Their size and form are lated to those of the cortical receptive field (RF). The process exists for strict timing parameters, of which inter-stimulus interval (ISI) has a major influence. BD (Burst Durations) roust be in the order of 5 ms for maximum effect. The vividness and strength of the saltatory effect is supported by psycho-physical data. Thus the effect is determined by the ISI (which has to be less than 200 ms), the Bd, the intensity of the signals and the placement of the 2 stimuli.

A reference regarding such stimuli is as follows; Cholewiak, R. W., and Collins, A. A. (2000). The generation of vibrotactile patterns on a linear array: influences of body site, space and time. Perception and Psychophysics. 62(6); p. 1220-1235.

The belt receives a queue of waypoints from the server. The last waypoint is the final destination. The collection of waypoints are provided as geographical coordinates (i.e., latitude, longitude). A suite of sensors onboard the controller is used to determine the current location of the user. A GPS and a collection of other sensors (inertial, gryoscopes, altimeter, magnetometer) are used to determine the current location. The current location is compared against the current waypoint. The difference between the locations is used to determine what motor to fire. It is possible that if the difference desired direction falls between 2 cardinal locations and thus those 2 cardinal motors can be activated proportional such that saltation can produce the desired perceptual heading.

The haptic navigational device requires calibration to cater to the individual users ability to perceive tactile responses.

There are 4 processes of calibration.

Physical calibration—One process is physical calibration that involves verifying that the 4 motors are placed at the cardinal locations and that the user can: clearly discriminate each motor uniquely with regards to its spatial placement in reference to the neighbouring (i.e., closest physically mounted motor) motor. It is known from the literature that the body midlines are more sensitive than the other areas; thus, the 0 and 180 degree locations (N. and S.) should be easily identifiable while the other locations (E., W.) will be subjective. Depending on the placement on the body, the 2 point discrimination task is what defines how close the motors can be. For example, for different body parts, the 2 point discrimination thresholds are approximately: belly—35 mm, back—40 mm, thigh—45 mm, calf—46 mm, foot sole—20 mm, forehead—20 mm, breast—30 mm, upper arm—45 mm, forearm—38 mm and fingers—3 mm. These values will be used as increments to move the motors along the belt when verifying with the user.

Subjective magnitude—Another process determines the subjective magnitude for new levels of discriminable amplitude (should be in the range of 0.4-2.3 db per level). The maximum level will be determined by the physical amplitude constraints of the actuator used. The other discrete levels will be determined by their differentiability from other levels. This test will ask the user tor the maximum level intensity. Subsequent decreases in decrements of 1 db will identity the number of levels for the particular user. Since each of the 4 motors may vary, we will take the worst case and use it for all the motors. The levels of amplitude can be used to differentiate the distance to the target, the strongest annunciation will refer to the target being close, i.e. inversely proportionate. Note that the contactor (motor, tactor) size influences the detection thresholds for amplitude, the larger the surface area with the body in contact with the motor, the amplitude threshold decreases. The amplitude of vibrotactile sensitivity varies across the body, not all body parts are as sensitive. For example, the forearm is 25 db relative to 1.0 micron peak skin displacement while the distal part of the middle finger is only −20 db. The db range is determined by P=10 log(1)(P2/P1). The subjective magnitude of tactile stimuli applied on less sensitive body parts increases more rapidly (e.g., fingers vs. forearms). It is imperative that the maximum power level does not exceed the pain threshold of the user, it is highly unlikely. The tactile stimulus beyond 55 db above the corresponding detection threshold value feels painful.

Burst durations—Another process determines the burst durations that are comfortable to the user. The minimal value should be in the order of 20 ms and likely to be less than 100 ms. The process will start the test with a value of 20 ms and increment the durations by 10 ms increments until a comfortable value is obtained.

Saltation effect—The saltation effect is independent of the intensity value and is highly dependent on the ISI (Inter Stimulus Interval). The ISI is in the order of 60-500 ms. The amount of mis-location towards the latter stimulus is dependent on a decreasing ISI. The ordering of which motor fires first will be determined from this calibration. In order to calibrate, initially the ISI will be set to 60 ms and incremented in 20 ms increments until the user identifies the location of the intended stimulus. We will evaluate for interpolations that are ¼, ½ and ¾ between the 2 stimulating motors. (As a general comment tests have shown that gender does not usually provide any difference. However, with age, tactile sensation at threshold and supra-threshold values are negatively affected by advancing age (See: references, Summers, Goldstein).) The unit power management system is controlled by a separate accelerometer. If the unit is not moving as sensed by the accelerometer, the whole unit goes to a sleep mode and thus conserving power. The unit can either communicate via bluetooth, wi-fi or cellular. Depending on the preference of choice, the other modes will be shut off. To conserve power, only new values are transmitted (e.g., if the person is not moving, there is no need to transmit the same location).

The physical belt that is worn designed to be formed of material that accentuates the vibration in the vertical direction towards the skin and dampens the vibration in the horizontal direction. For example, the physical belt may be formed of neoprene. This aspect of the belt is important because the vibration area is focused on the area of application and is not spread out over a larger area but is rather concentrated where the motor is placed. If the vibration was allowed to spread out as opposed to being concentrated, then the effect of saltation would not be as defined (i.e., there would be less intermediate phantom sensations that could be created). The electrical connectors that connect the actuators to the controller use electrical conducting fibres that stretch. This is unique in that the belt can stretch to the comfort level of the user irregardless of the placement of the motors, the electrical conducting fibre will stretch with the material. Thus the motors in the belt become one with the material.

The present invention further permits remote devices to connect to it via a bluetooth interface. If these additional accessories were medical devices that measured physiological signals, then the wayfinding device can also geo-stamp medical signals in addition to location and motion information. Examples of physiological signals include ECG, EMG and EEG as well as body temperature, galvanic skin response to name a few. The device is now able to collect medical data that is geo-stamped so that medical professions are able to also have geographical information on where the medical signals were recorded as well as what the person was doing, based on the motion sensor signals.

The belt controller can be operated independently or in conjunction with a phone that is worn by the user. The belt controller has a built in GSM module which essentially is a cell phone.

As described herein there are many possible embodiments of the present invention. In one embodiment of the present invention, the system may incorporate a cloud server. In such an embodiment, the collection of data from the sensors on the controller is managed by an onboard software controller. The controller collects the readings from the different sensors, sends them to a display interface on the phone and to the Tactile Belt Communication Server (TBCS), receives navigational information back from the TBCS and performs the analysis to determine how the belt should vibrate. On the smart phone this server is implemented as a background service that starts by default whenever the device is started and that is restarted whenever it crashes. The controller consists of four main threads.

Main Thread—The main thread that manages the operations of the tactile belt and maintains a data structure that contains all the run-time parameters and all the measurement data.

Server Thread—The Server Thread responsible of maintaining the communication with the server including encoding messages to be sent to the server and decoding incoming messages and sending them to the data structure of the background service.

Belt Thread—The Belt Thread responsible of maintaining the communication with the belt including encoding messages to be sent to the Belt and decoding messages received from the belt. This Thread maintains a queue of messages. This way it can handle both synchronous poll messages that are sent every fixed time interval and asynchronous messages that are sent at random times.

Navigation Thread—The Navigation Thread takes as input the sensors readings and the navigational information provided by the TBCS server and outputs the corresponding duty cycle of the motors.

As shown in FIG. 8, the device can operate with an attached gsm module or with an off board phone. Software may reside in the off board phone.

The belt may be designed to incorporate of conductive fibres that are sewn directly into the belt material. These are different than electrical wires in that they can be sewn into fabric, stretch and can conduct. In order to overcome the problem of interfacing normal electrical wire to these fibres are interfaced via a unique material called pyralux that permits fibre to be sewn into it as well as it also permits electrical wire to be soldered onto it.

Vital signs of a user may be obtained from an off the shelf unit such as the Numetrex Mens Cardio™ shirt which transmits heart rate via bluetooth which is recorded by our belt controller.

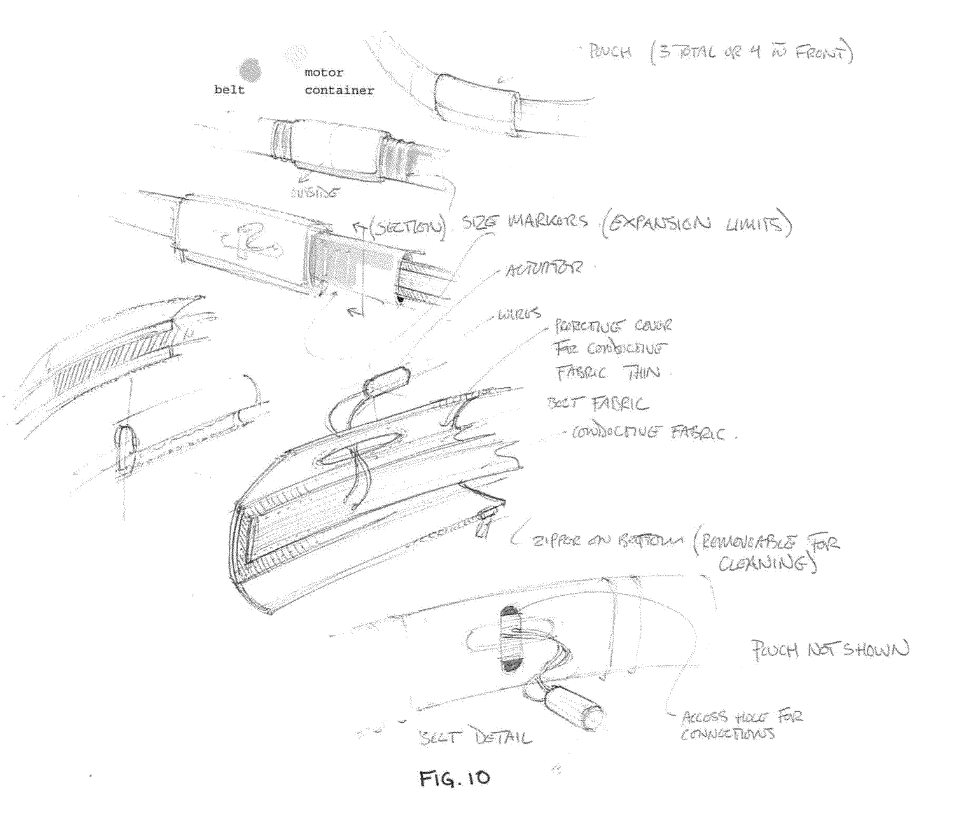

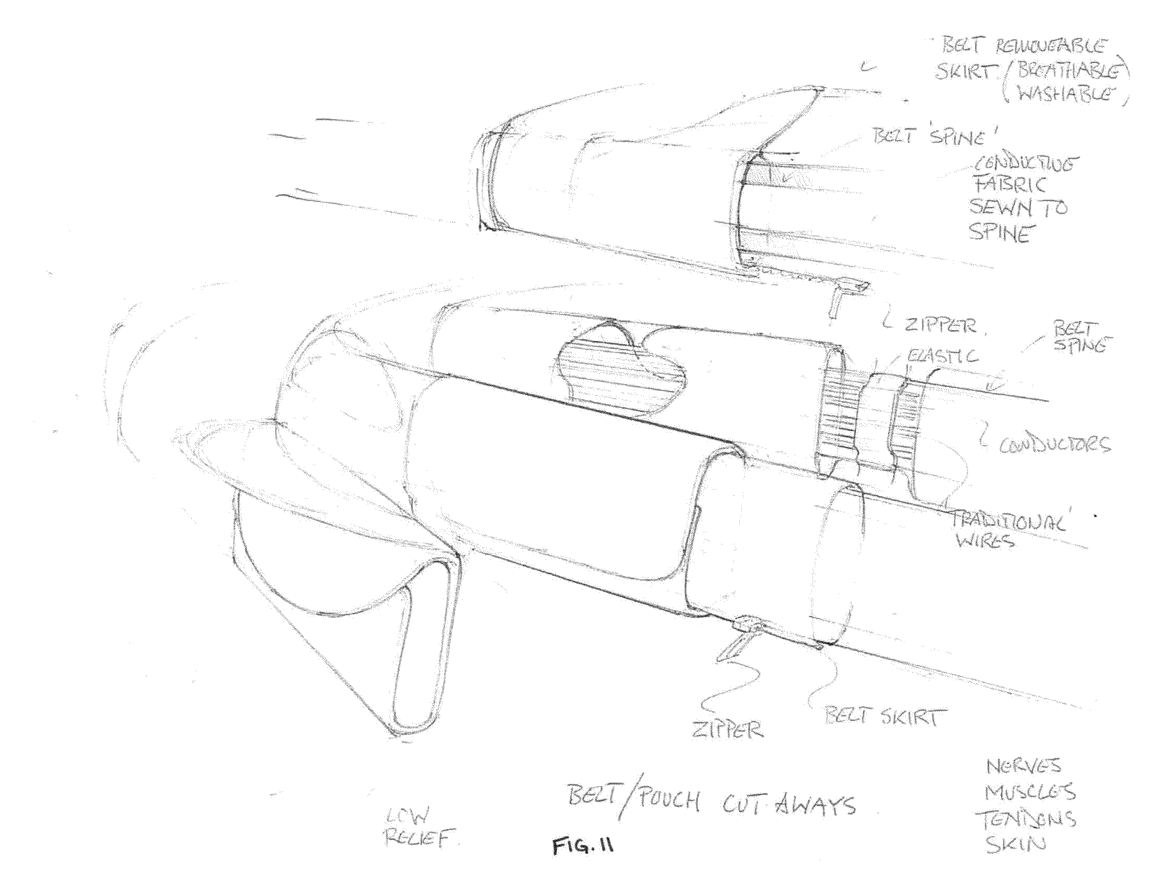

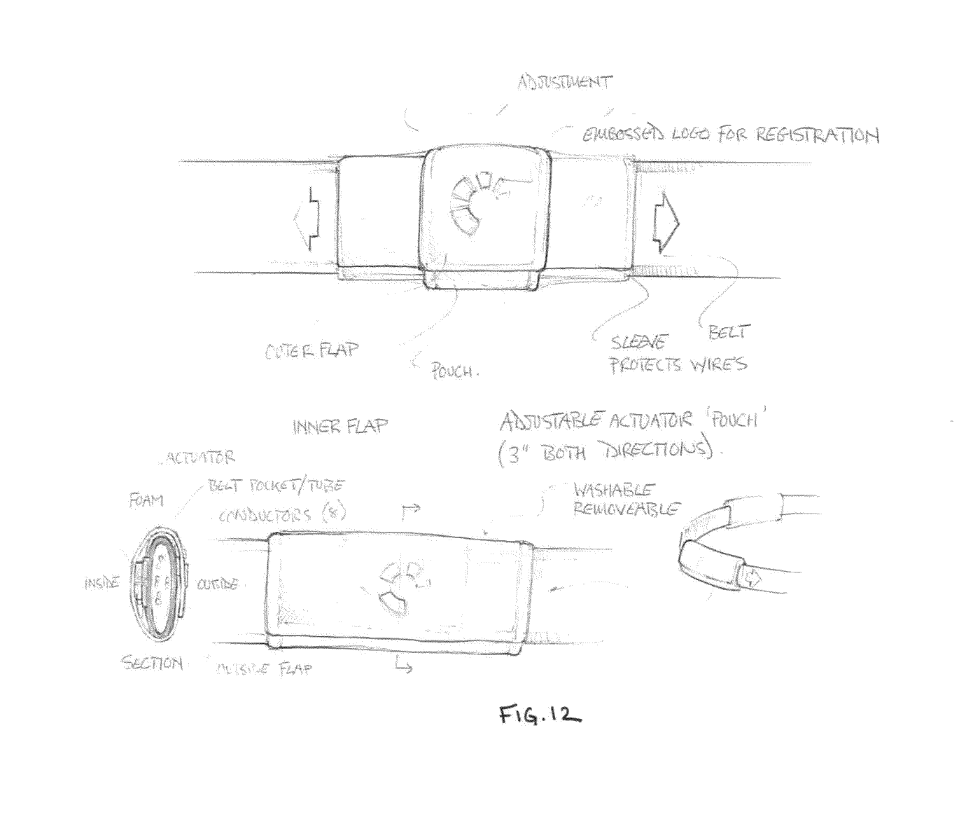

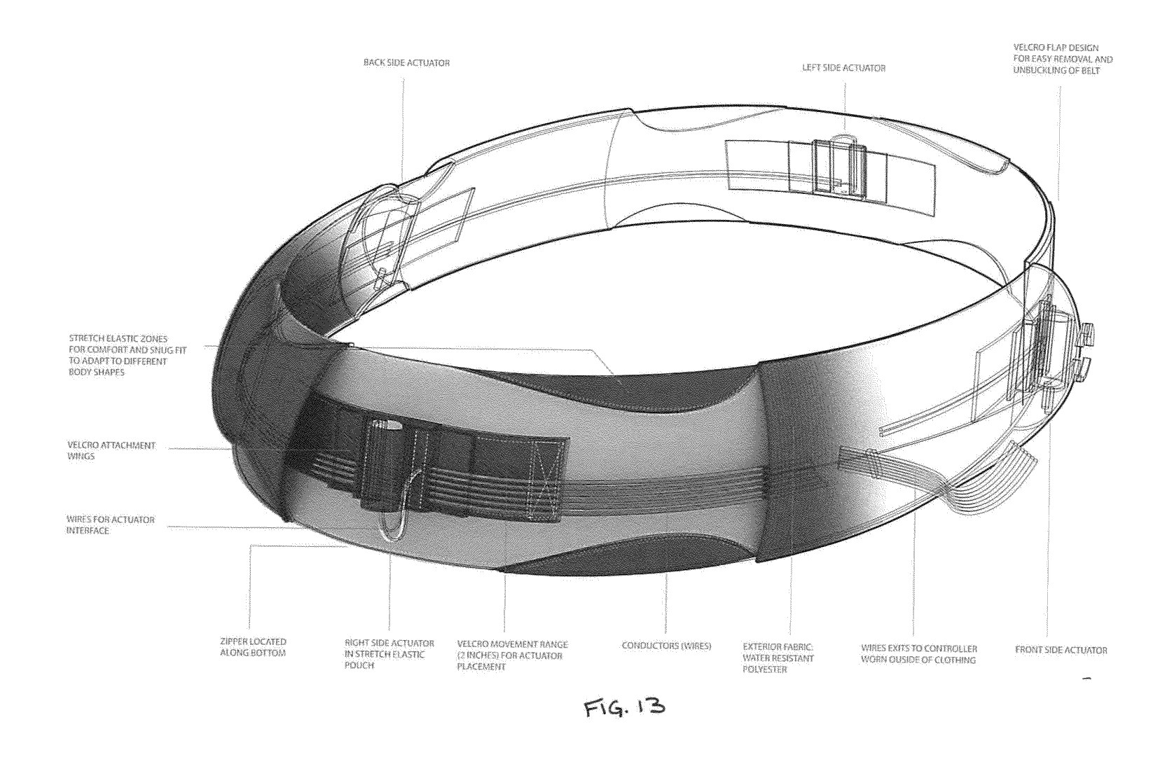

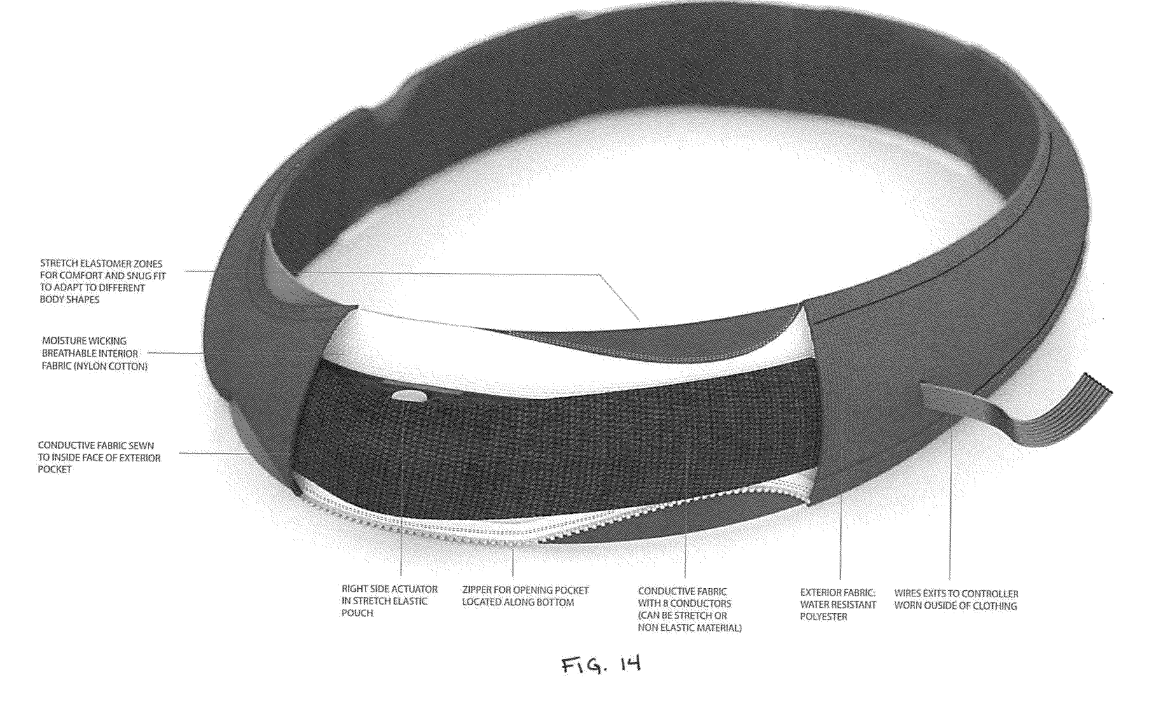

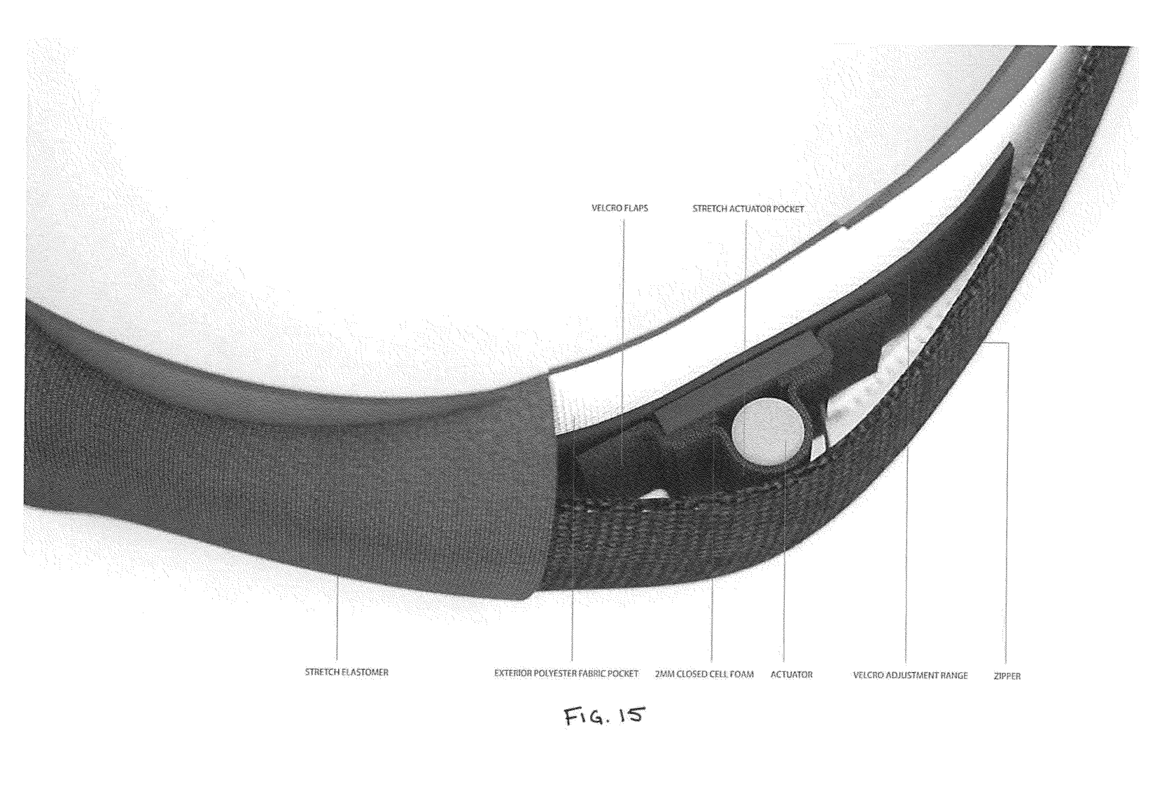

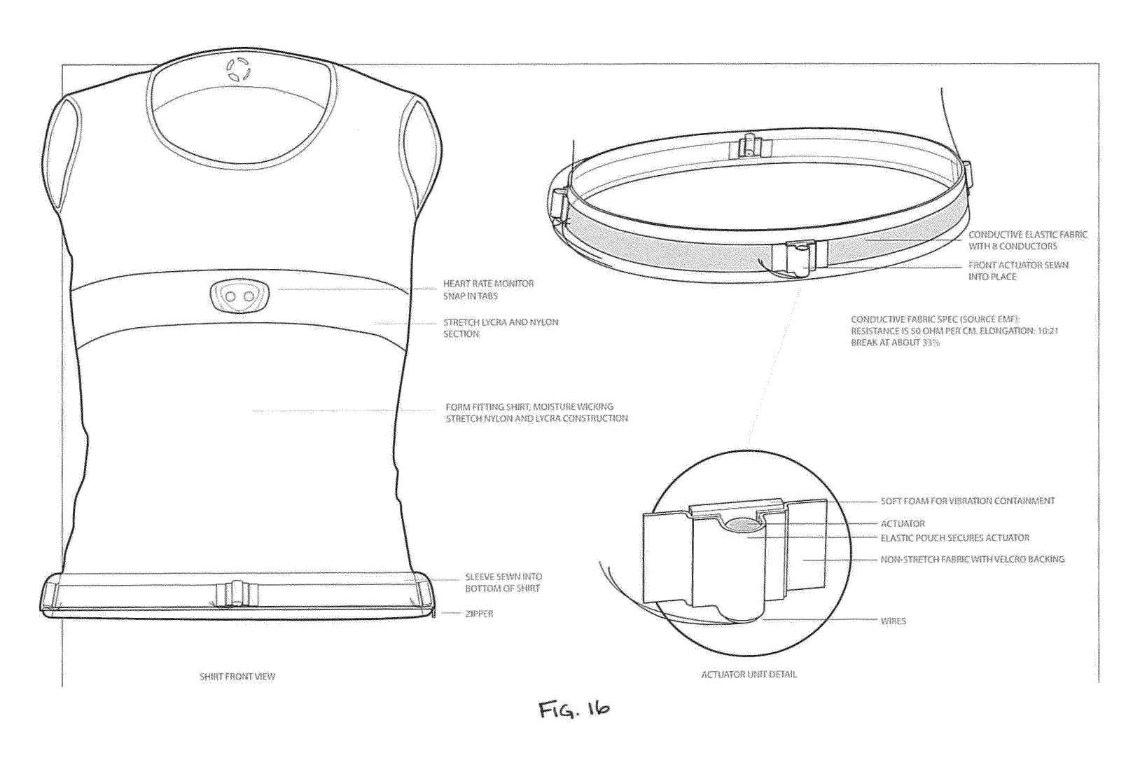

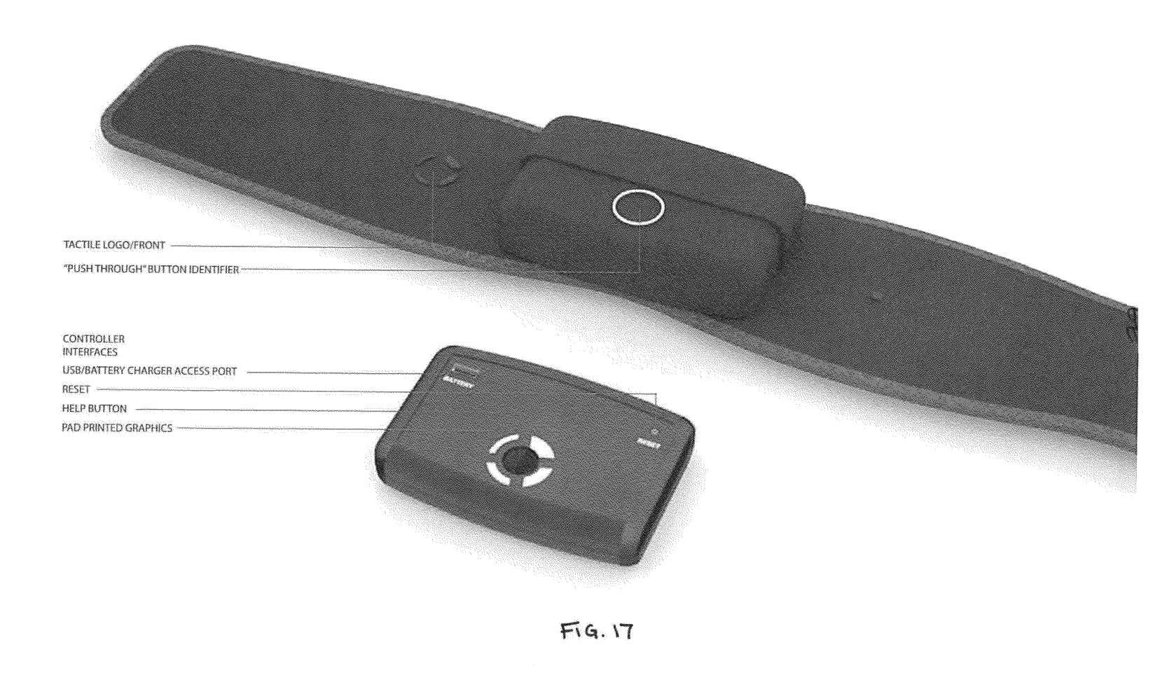

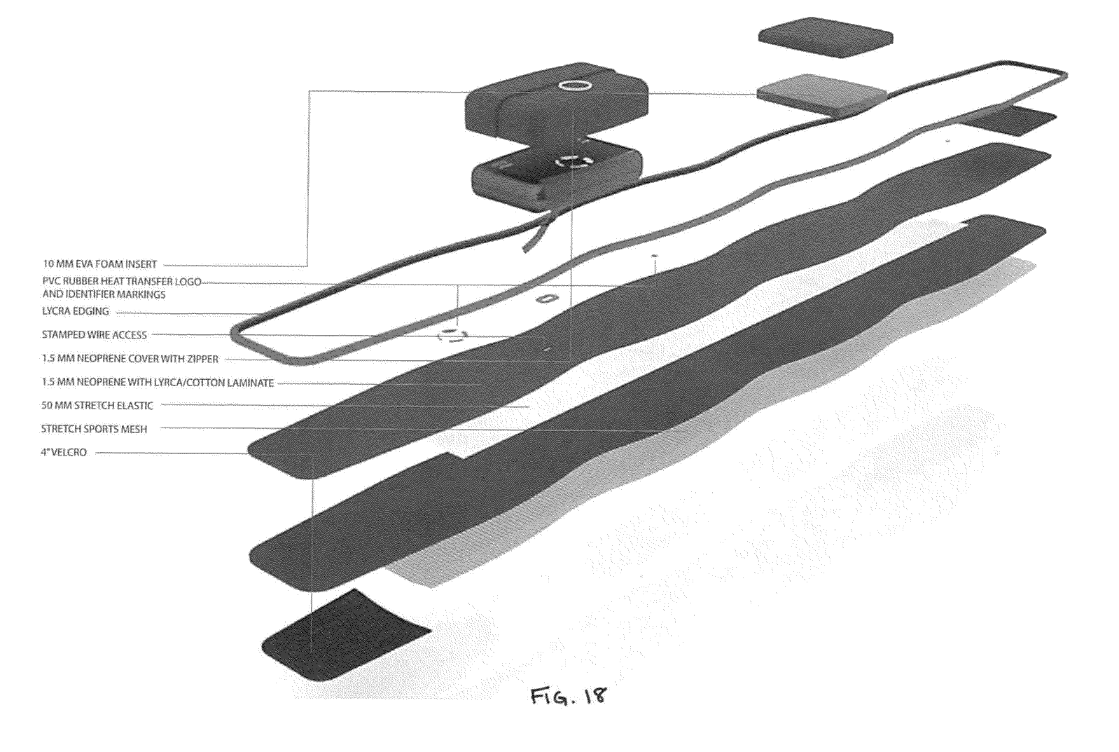

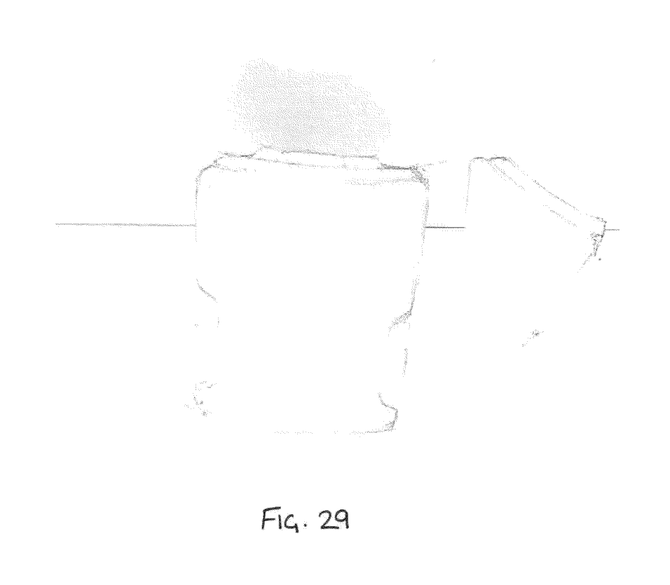

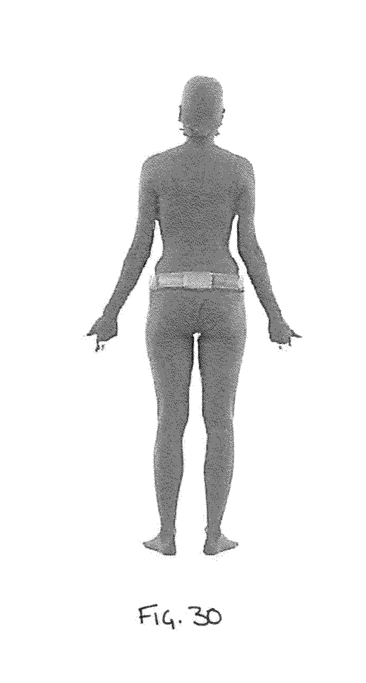

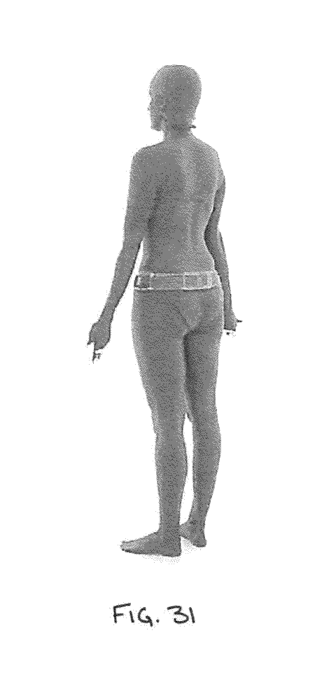

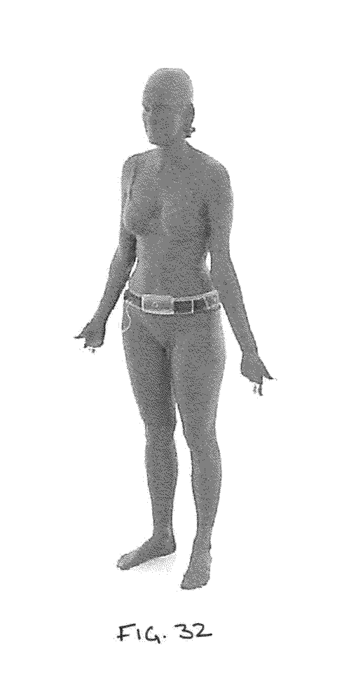

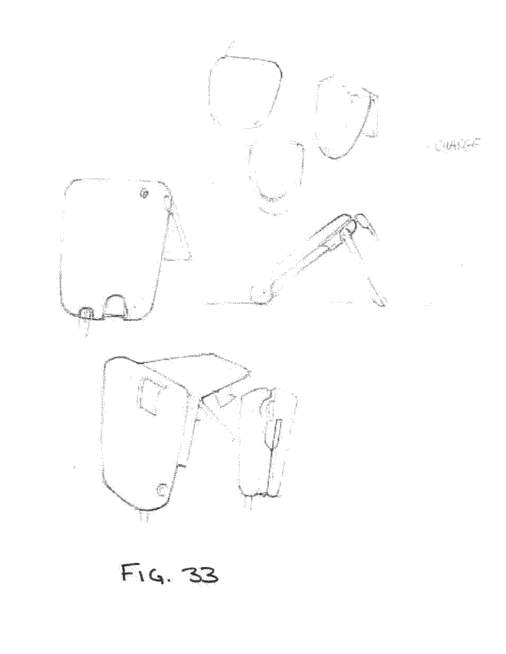

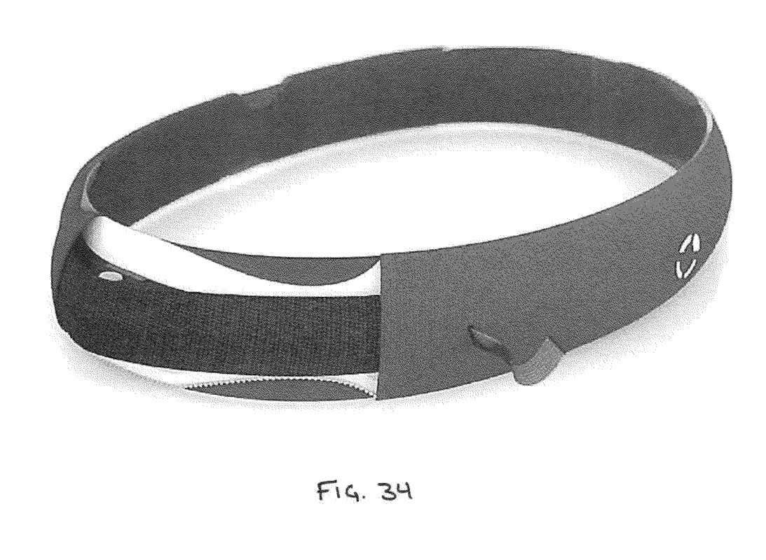

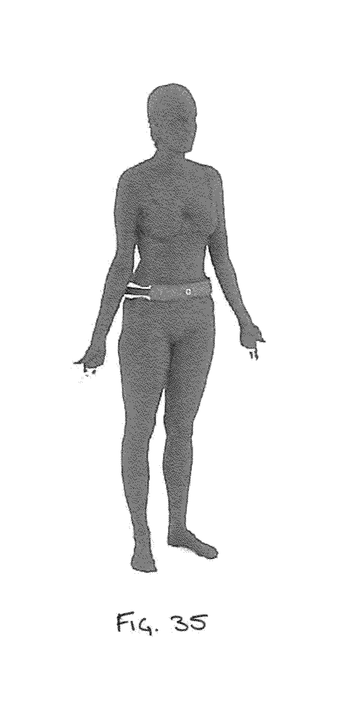

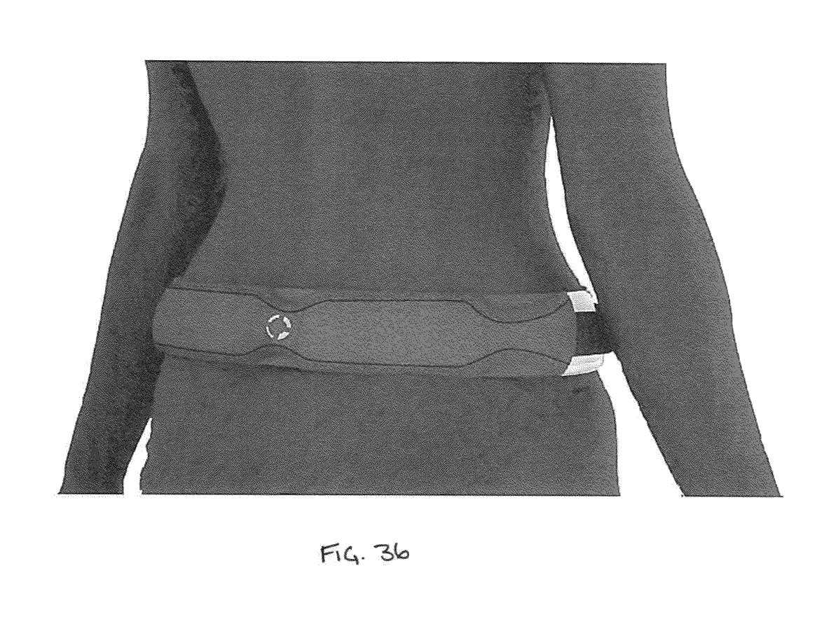

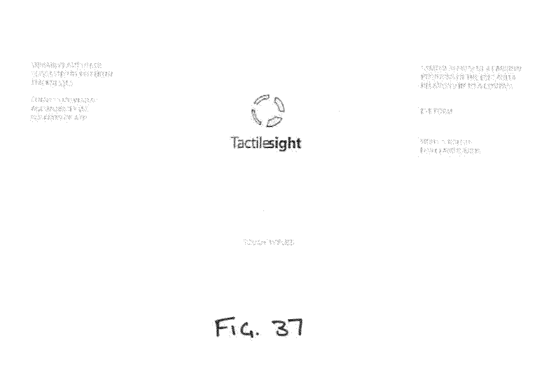

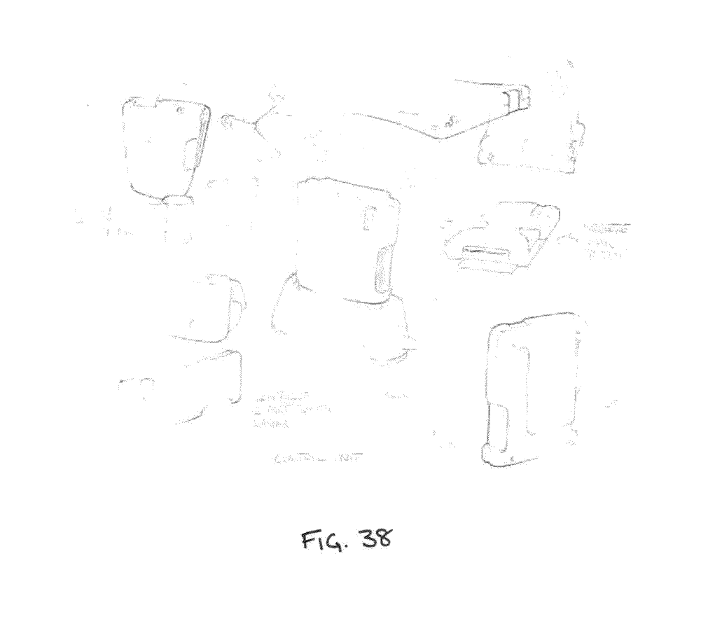

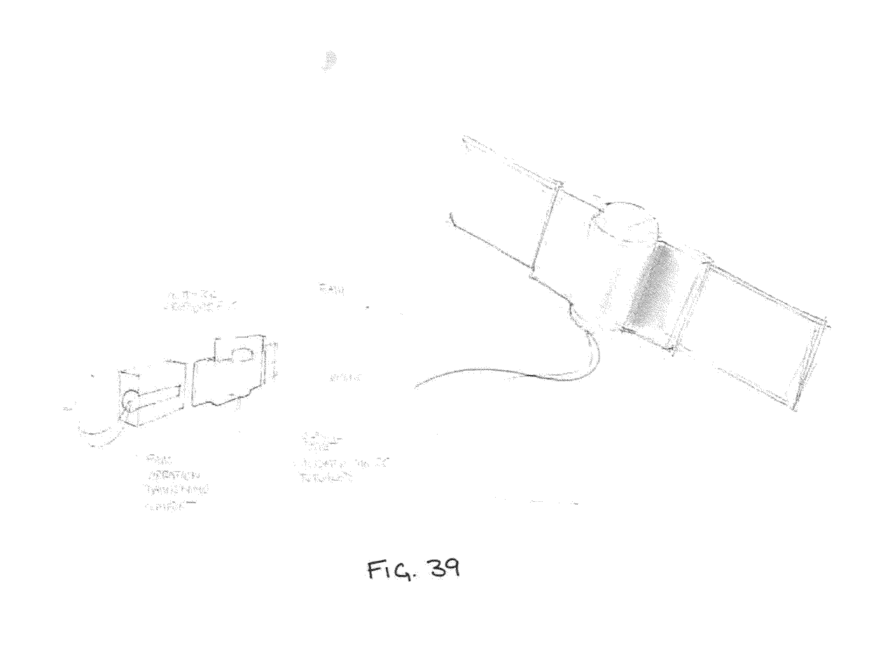

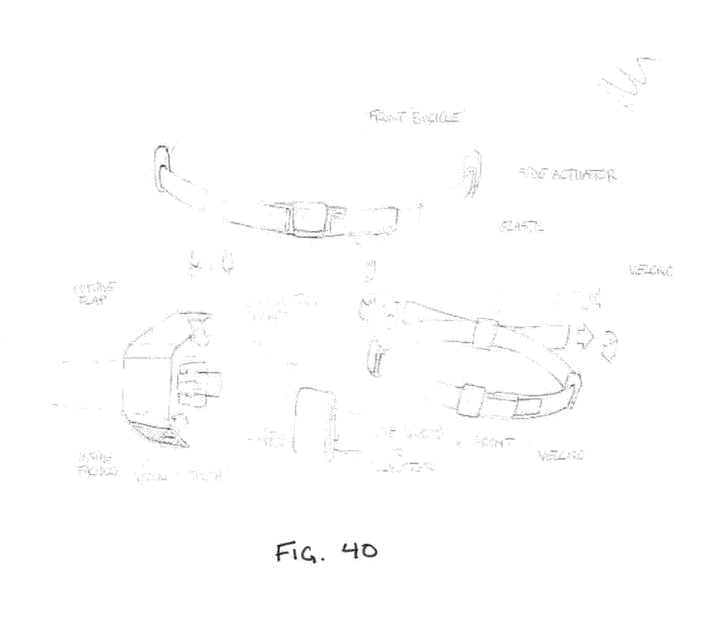

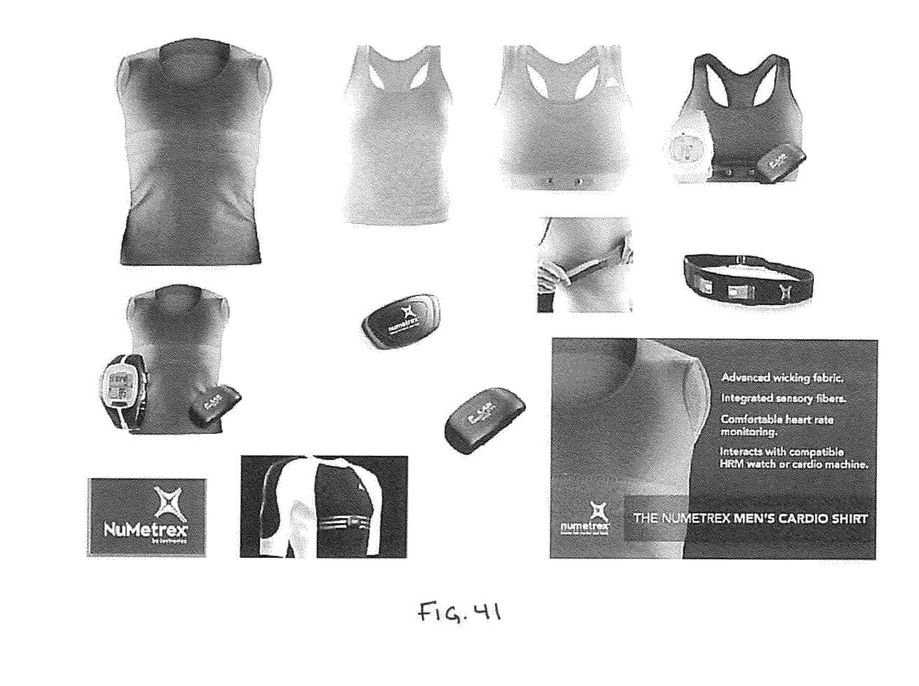

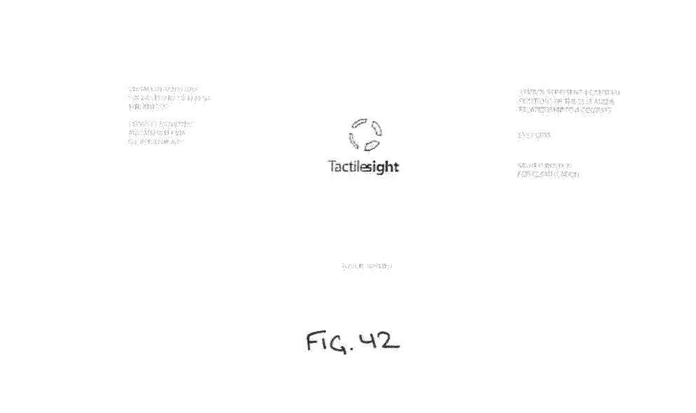

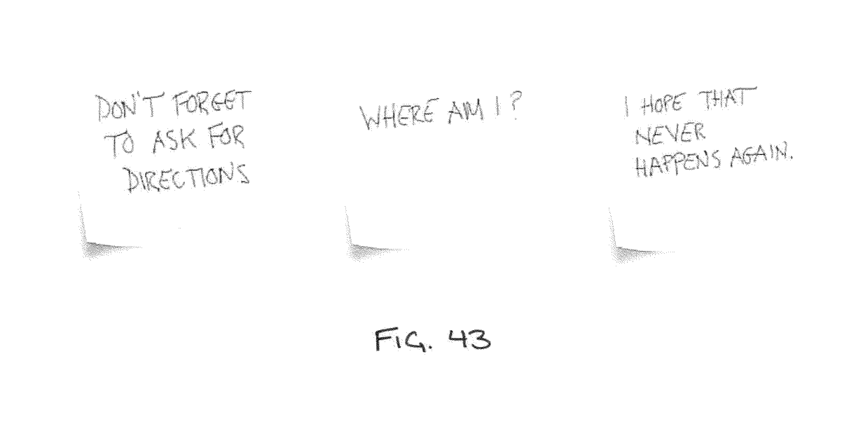

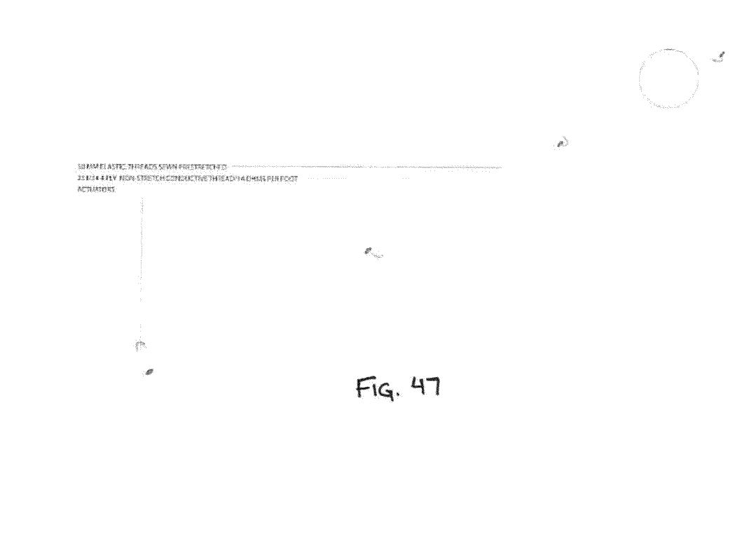

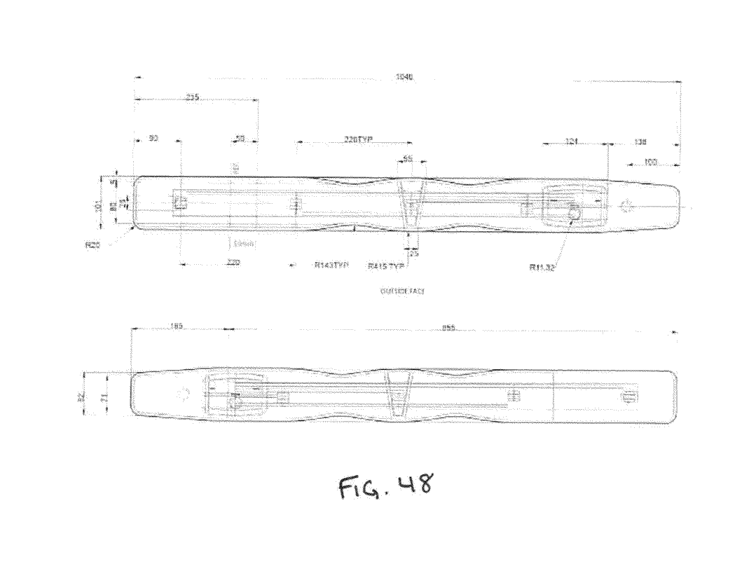

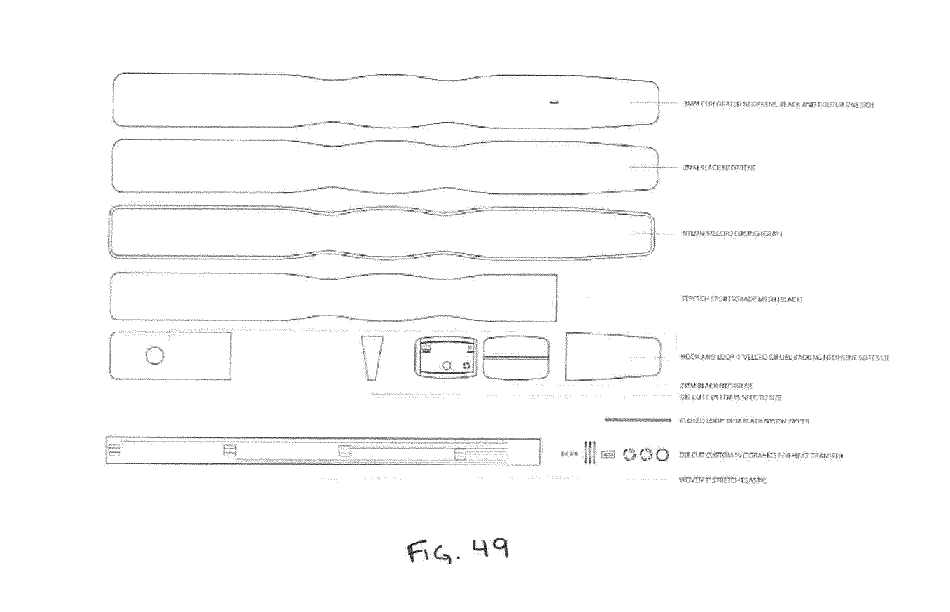

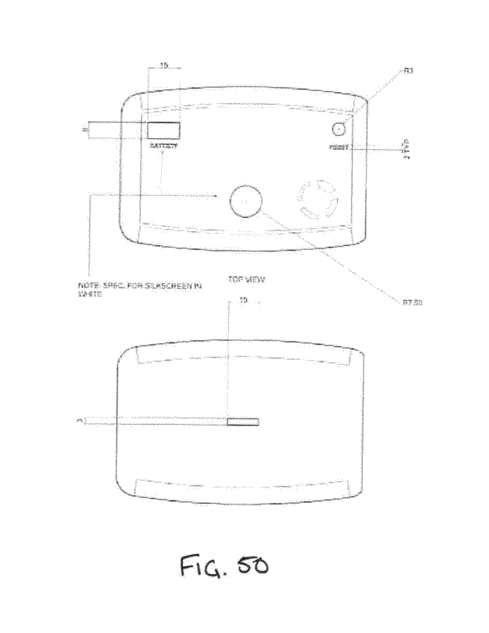

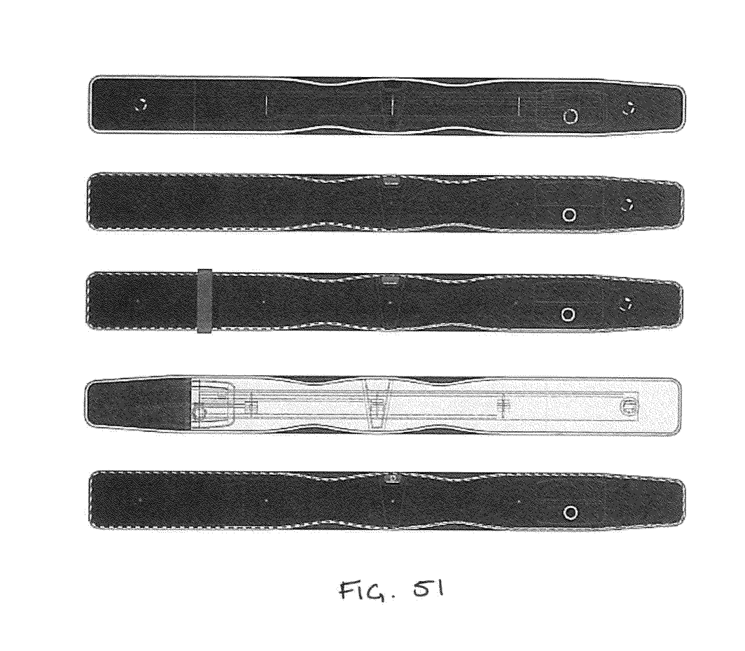

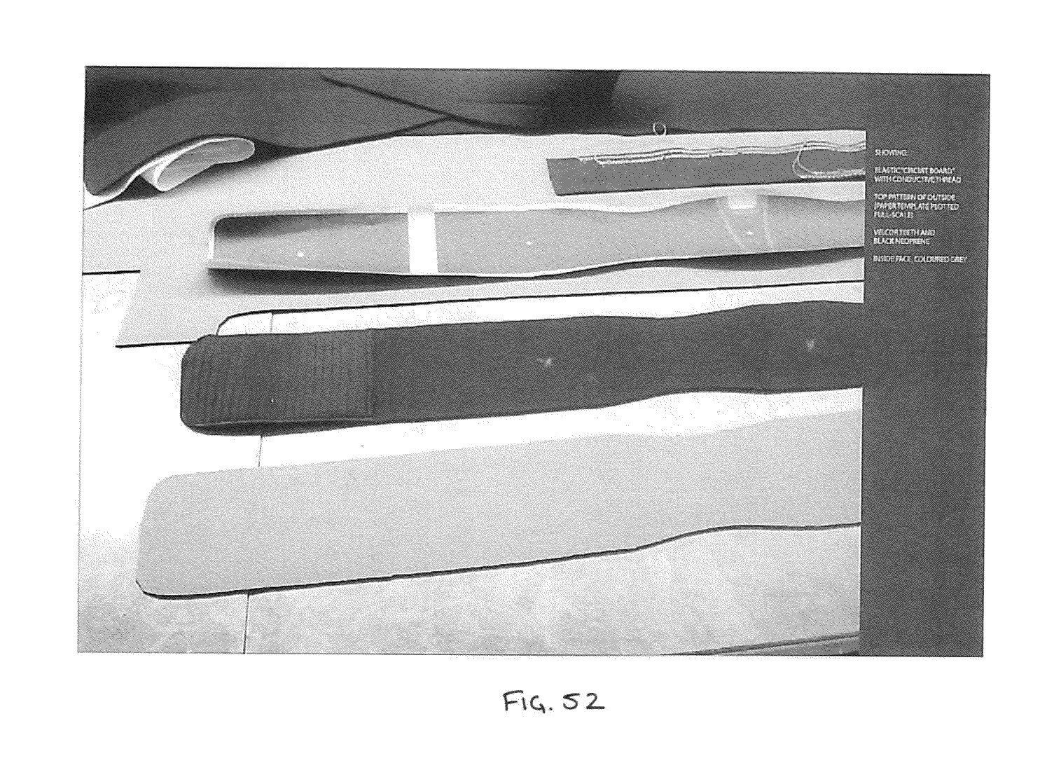

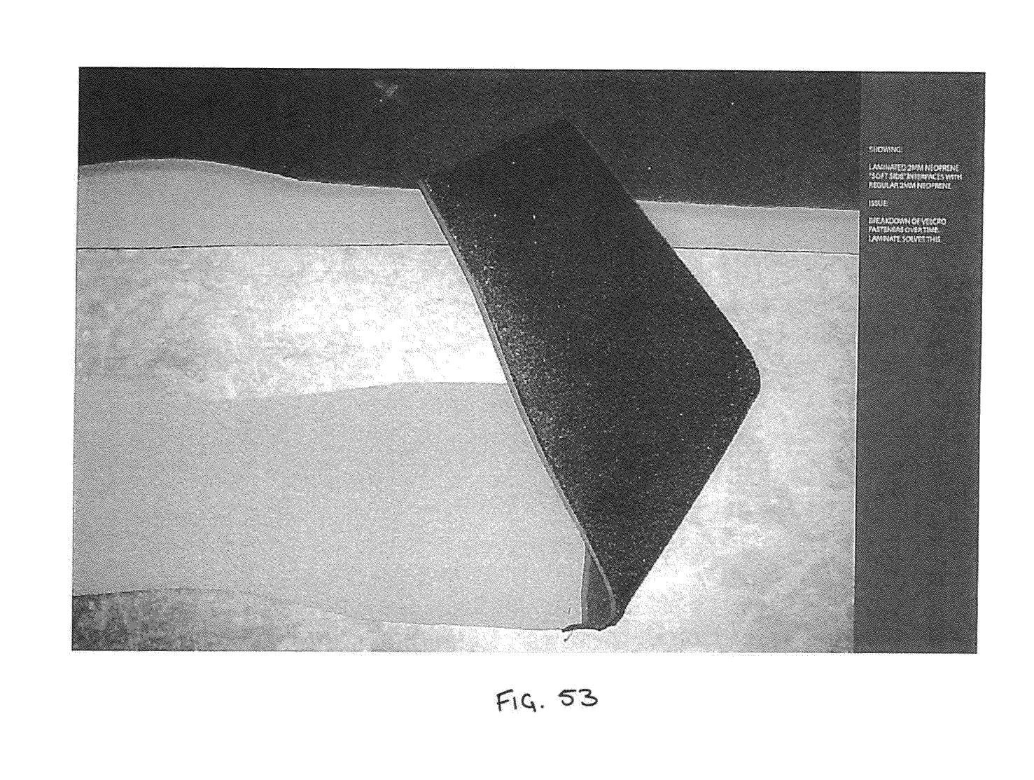

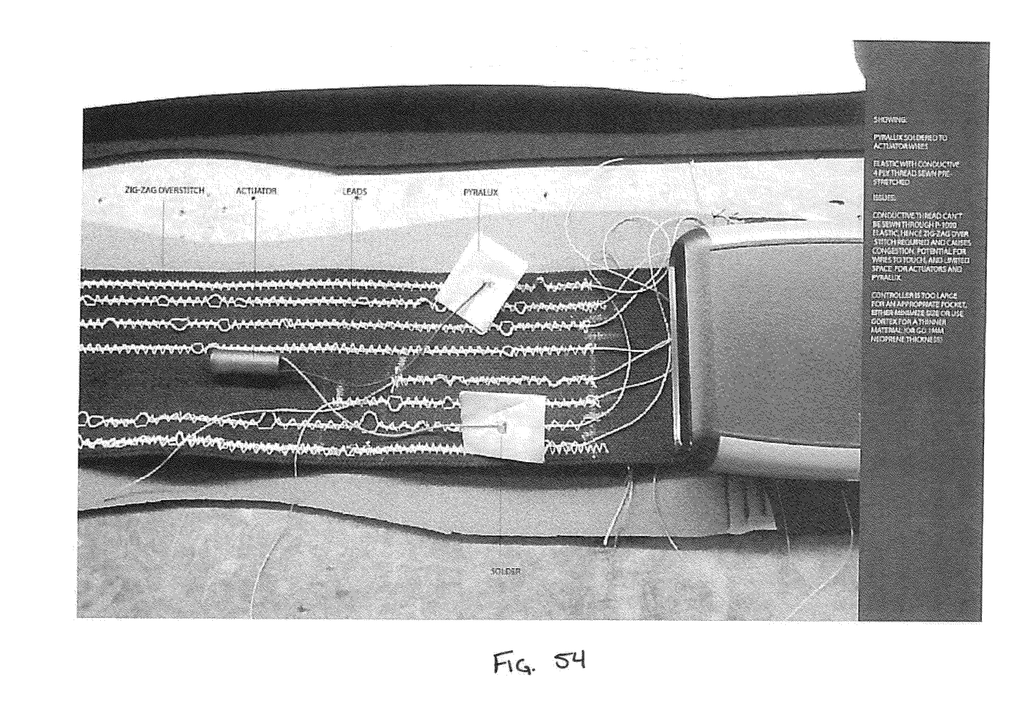

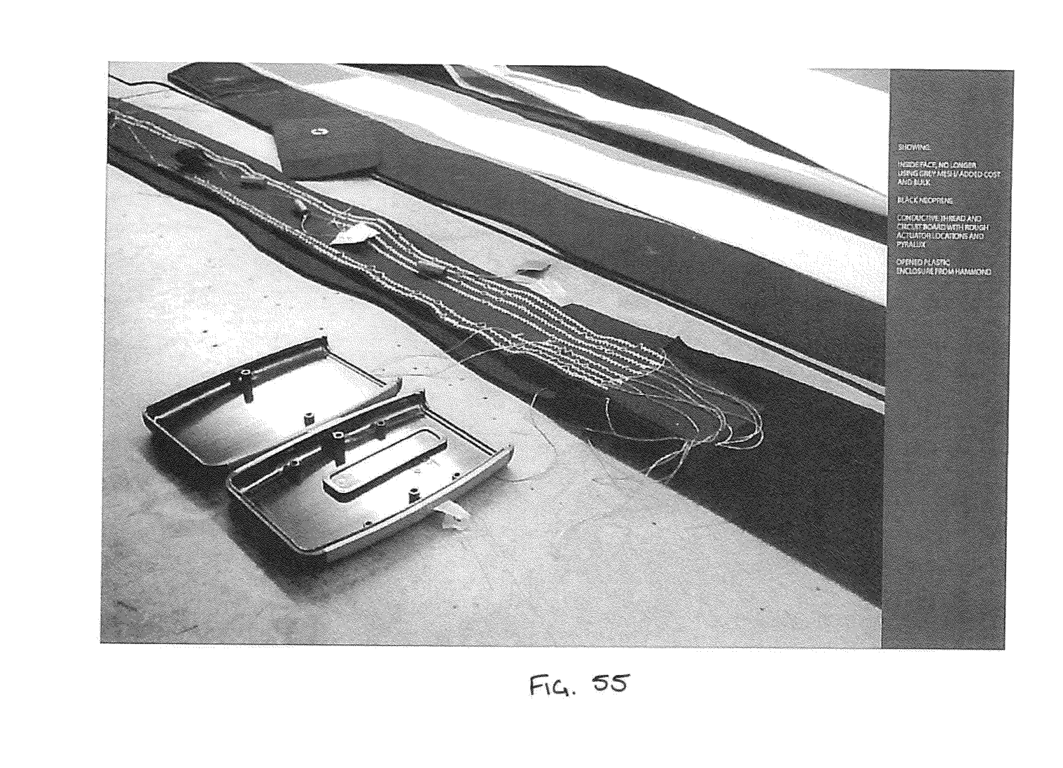

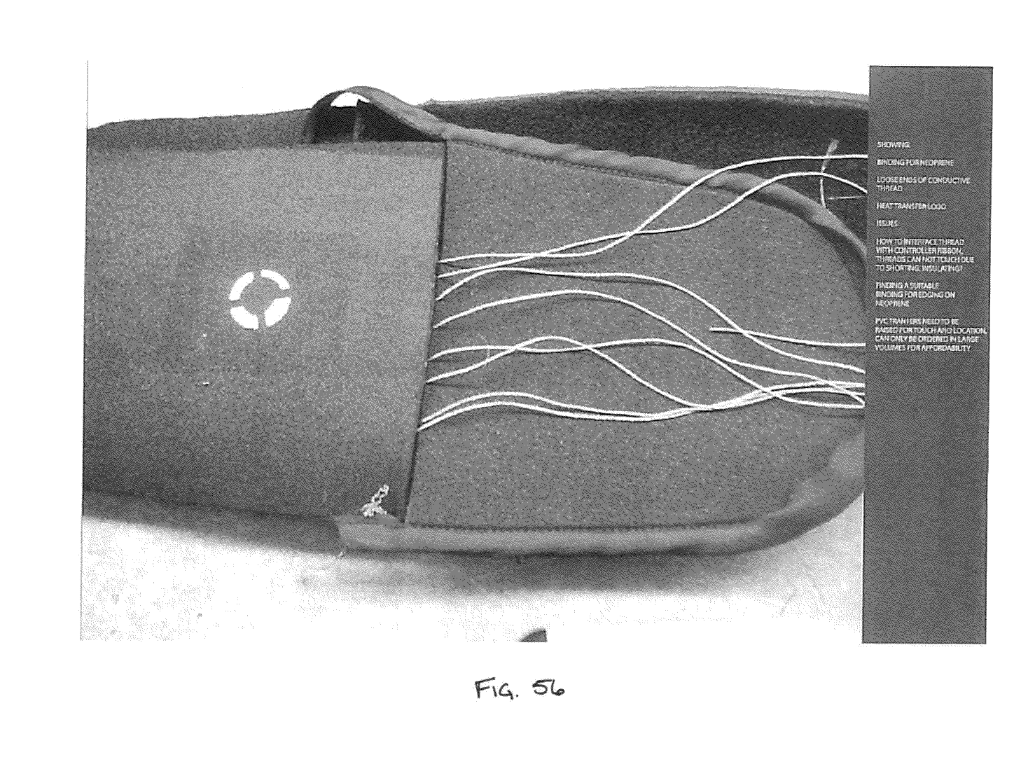

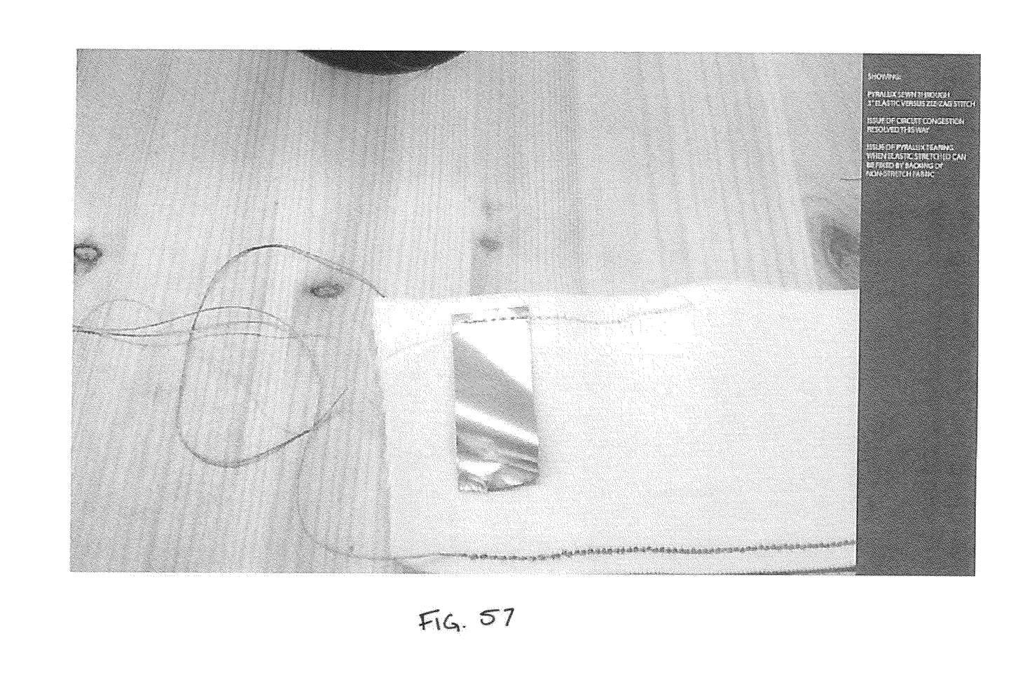

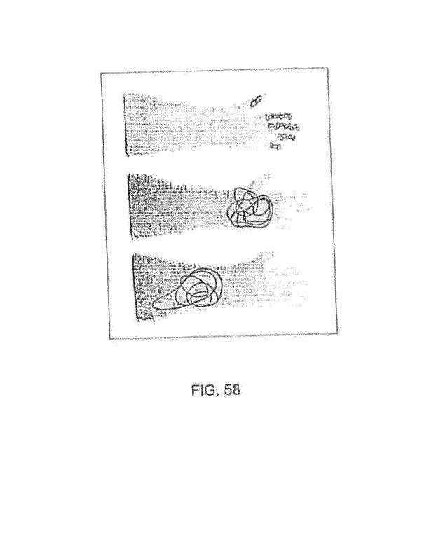

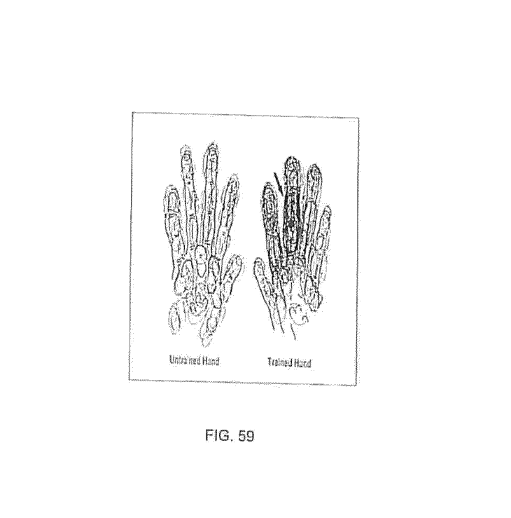

Examples of embodiments of the present invention, including configurations of belt design, are shown in FIGS. 9-18 and 29-57.

The system shown in FIG. 6 incorporates a database that stores information relating to the user and all the settings and commands provided by the authorized monitor (for example, such as the care taker, a family member, etc.). Two servers interact with this database: (1) The Tactile Belt Web Server (TBWS) which provides a web based access to the database. (2) The Tactile Belt Communication Server (TBCS) which interacts with the belt controller either directly or via a smart phone. The interaction between the TBCS and the belt controller happen according to the Tactile Belt Communication Protocol (TBCP) over TCP.

The Tactile Belt Communication Protocol (TBCP) is a communication protocol that governs the transfer, in TCP packets, of information between the database and the belt controller board. This protocol is a modied version of the openDMTP protocol
[http://www.opendmtp.org/] with extensions to allow for the transfer of additional information transfer such as belt motor status, person orientation, battery status, and accident indications. The TCBP provides also a way to send navigational information and commands from the database to the belt. The protocol uses symmetric key encryption to encrypt the transferred data.

The Tactile Belt Web Server (TBWS) is a web server that provides a web portal that allows the real time monitoring of the patient (via a map based interface) as well as sending commands such as setting or changing the destination, overriding the motors vibration and changing the settings on the device. The (TBWS) is based on the open source system openGTS.

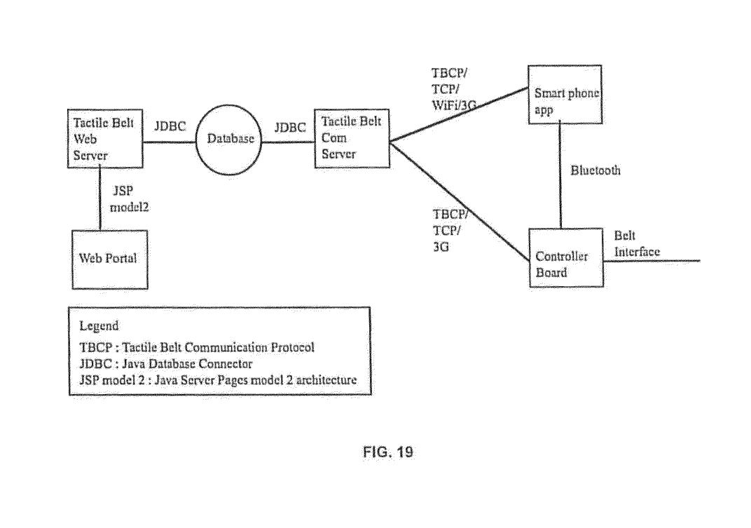

As shown in FIG. 19, in one embodiment of the present invention a web portal may be provided via a smart phone application, and these elements, as well as a controller board may exist external to the server.

In an embodiment of the present invention there may be two databases that are resident in a cloud server. The first database keeps a record of user preferences and the security control for the potential of mapping one user to many monitors or many users to one monitors and any permutation of the above. The second database is a dynamic one that records all activity by the users, all sensor readings including all vital signs and time and location stamps this information.

In one embodiment of the present invention, the monitor element may be a portal application that can be accessed from any internet device using a browser. The user interface relies on using a displayed map (e.g., Google map) that shows the user's location and progress. A personalized interface containing a picture of the user, a user profile, history, a memory of favorite routes as well as belt settings. Emergency contacts are also referenced so that the monitor can also contact these individuals.

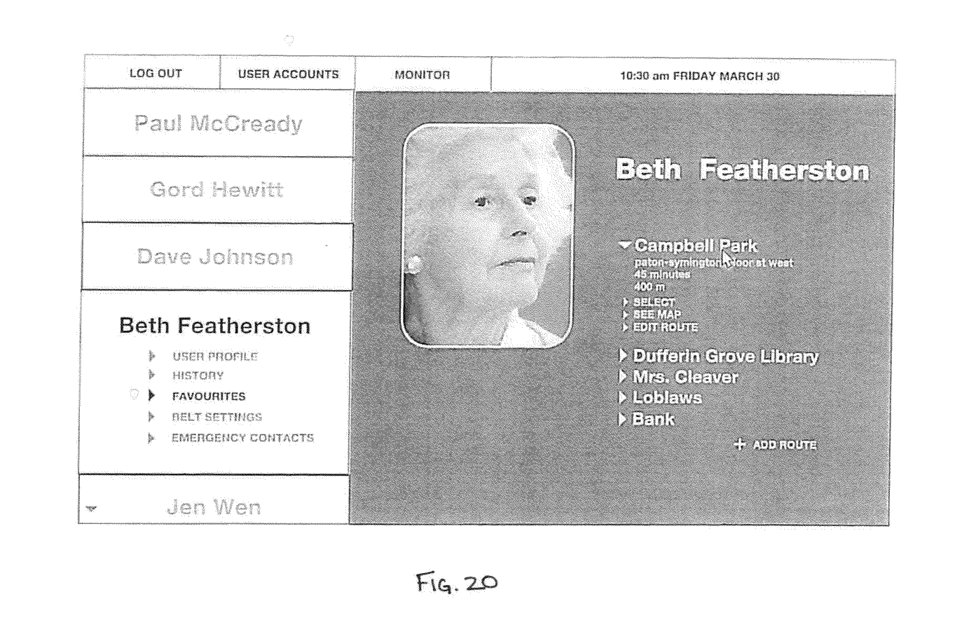

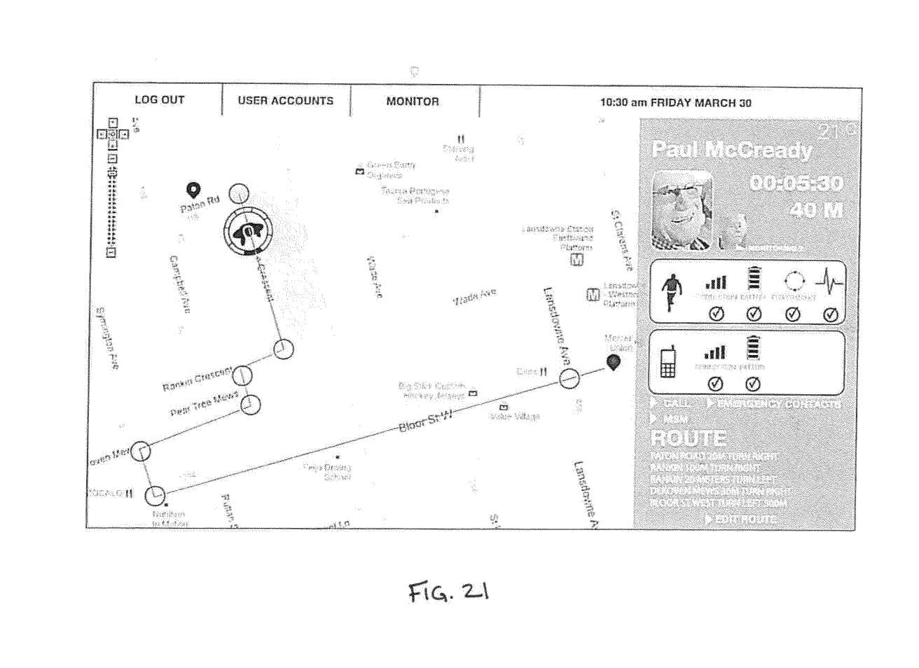

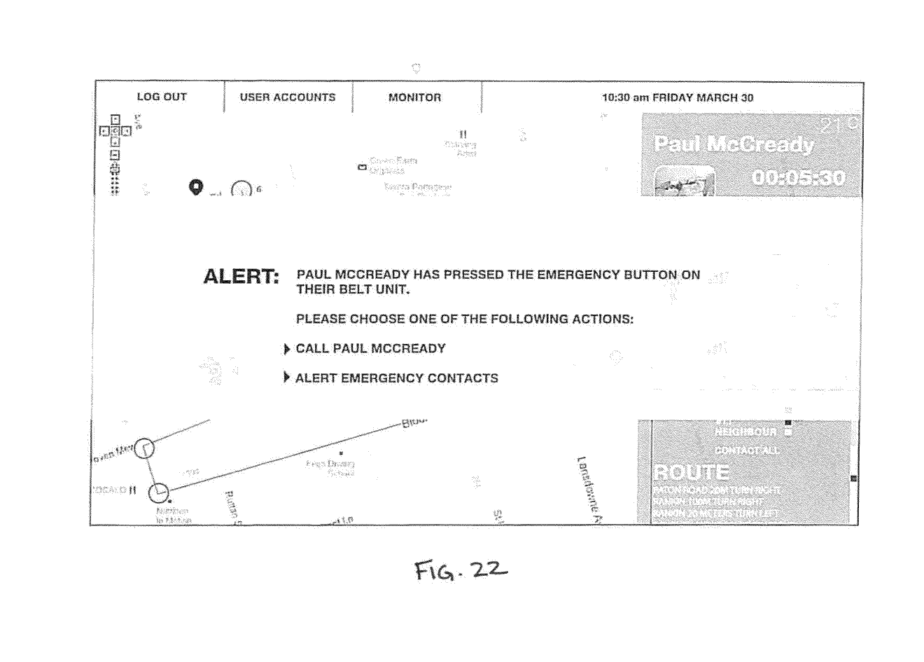

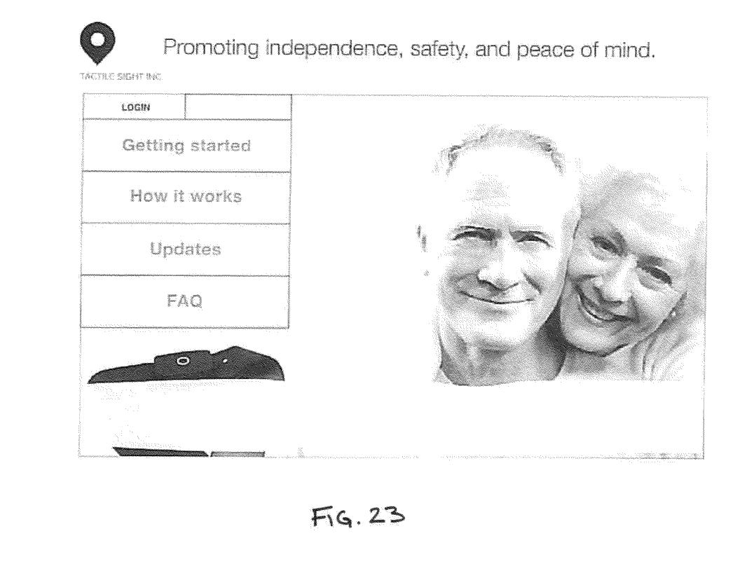

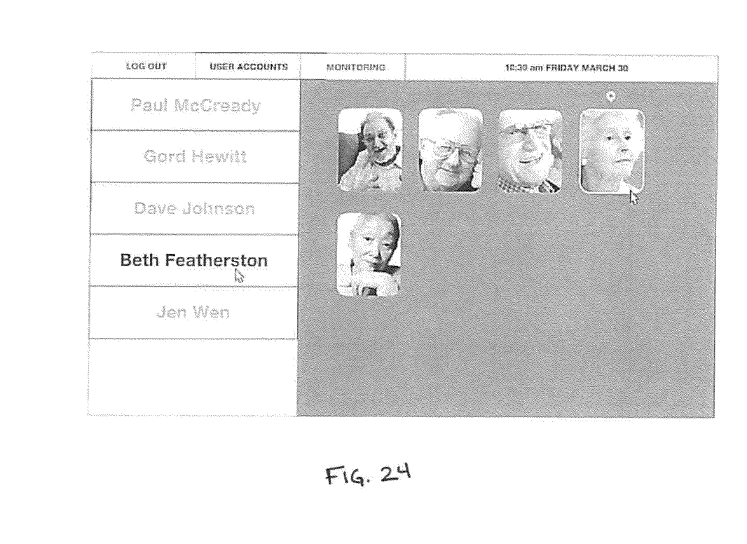

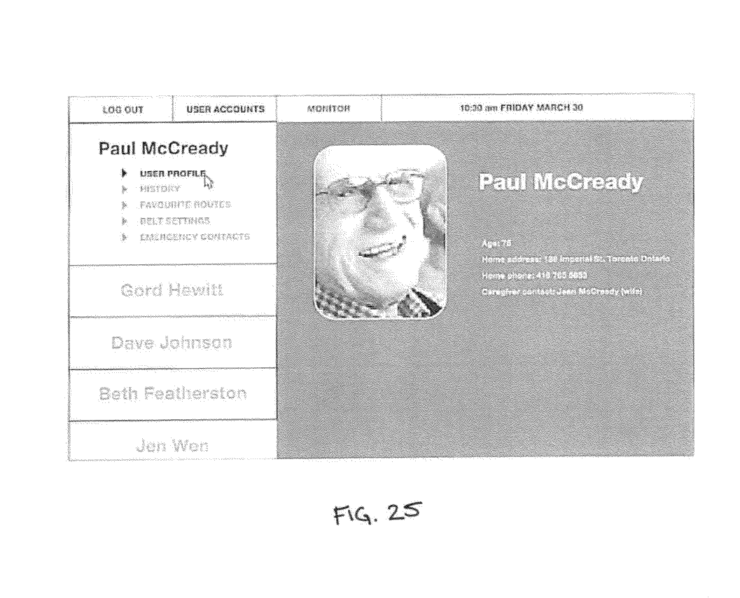

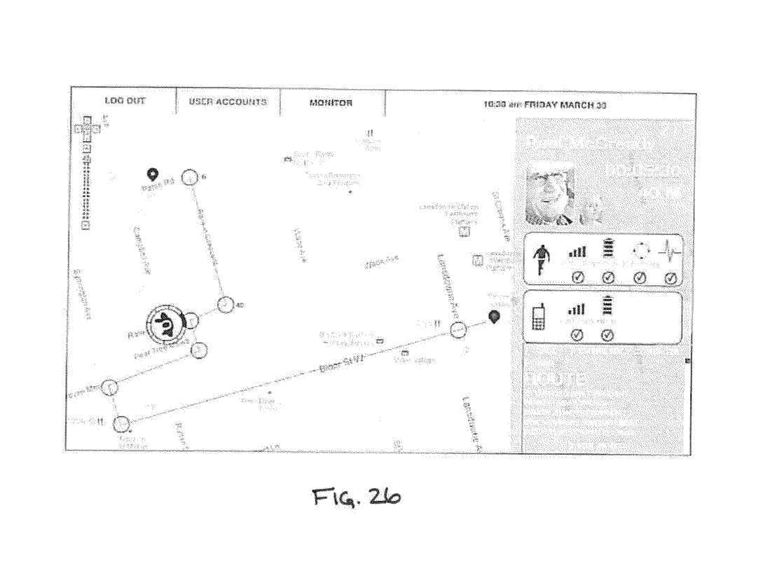

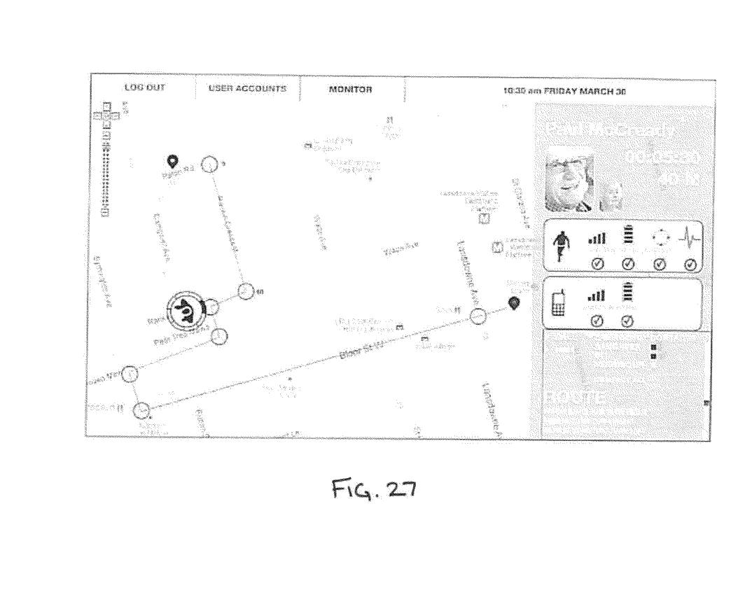

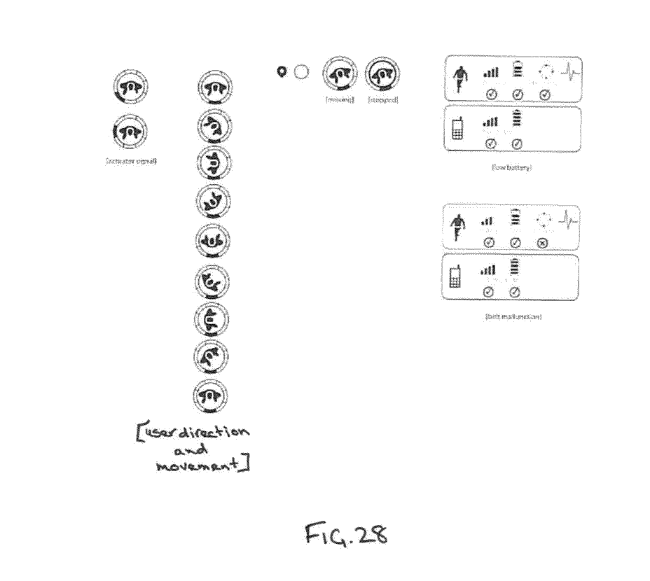

Example of web pages that may be incorporated in a monitor element are shown in FIGS. 20-28.

Technical Challenges Addressed & to be Addressed

Embodiments of the present invention address several technical challenges that existed in prior art system. For example, one such technical challenge was to incorporate sensitive sensors, wireless communications as well as amplifiers to drive the motors on a single board. The challenge was addressed by engineering the hardware to isolate the necessary components. Another challenge was that the GPS antenna was sensitive to the physical direction of placement and an omni directional antenna was chosen as a replacement. The back end server side manages the connections between users and caretakers. A server software system was setup to protect privacy of the users as well as the security of the data being transmitted.

One embodiment of the present invention may be utilized it as an infrastructure backbone for collecting physiological data while the user is engaged in their daily activities.

Embodiments of the present invention may be further be certified products, so that the cost for the user may be decreased by a rebate for the purpose of such certified products.

References cited herein, include:

[Ackerman, 1990] Ackerman, D. (1990). A Natural History of the Senses, Random House. isbn 0-679-73556-6.

[Asamura et al., 2001] Asamura, N., Shinohara, T., Tojo, T., Koshida, N., and Shinoda, H. (2001). Necessary spatial resolution for realistic tactile feeling display. In Proceedings of the 2001 IEEE International Conference on Robotics and Automation, pages 1851-1856, Seoul, Korea. IEEE.

[BachyRita et al., 1998] BachyRita, P., Kaczmarek, K. A., Tyler, M. E., and Garcia-Lara, J. (1998). Form perception with a 49-point electrotactile stimulus array on the tongue: A technical note. Journal of Rehabilitation Research and Development, 35(4):427-430.

[Barac-Chikoja and Turvey, 1991] Barac-Chikoja, D. and Turvey, M. (1991). Perceiving aperture size by striking. Journal of Experimental Psychology; Human Perception and Performance, 17:330-346.

[Blasch et al., 1997] Blasch, B. B., Wiener, W. R., and Welsh, R. L. (1997). Foundations of Orientation and Mobility, second edition. AFB Press.

[Bosman, 2003] Bosman, S. (2003). Gentleguide: An exploration of haptic output for indoors pedestrian guidance. In Springer, editor, Proc. Mobile HCl, volume LNCS 2795, pages 358-362.

[Craig and Rollman, 1990] Craig, J. C. and Rollman, G. B. (1990). Somesthesis. Annual Review Psychology, 50:305-331.

[Cytowic, 2002] Cytowic, R. E. (2002). Synesthesia: A Union of the Senses. MIT Press, second edition.

[Dobelle, 2000] Dobelle, W. (2000). Artificial vision for the blind by connecting a television camera to the visual cortex. ASAIO (American Society of Artificial Internal Organs). http://www.dobelle.com.

[Eimer et al., 2005] Eimer, M., Forster, B., and Vibell, J. (2005). Cutaneous saltation within and across arms: a new measure of the saltation illusion in somatosensation. Perception & Psychophysics, 67(3):458-468.

[Erp, 2005] Erp, J. B. F. V, (2005). Waypoint navigation with a vibrotactile waist belot. ACM Trans. on Applied PErception, 2(2):106-117.

[Geldard, 1957] Geldard, F. (1957), Adventures in tactile literacy. The American Psychologist, 12:115-124.

[Gescheider et al., 2004] Gescheider, G., Boanowski, S., and Verillo, R. (2004). Some characteristics of tactile channels. Behavioural Brain Research, 148:35-40.

[Goodman et al., 2005] Goodman, J., Brewster, S. A., and Gravy, P. (2005). How can we best use landmarks to support older people in navigation? Behaviour and Information Technology, 24(1):3-20.

[Harper, 1998] Harper, S. (1998). Standardising electronic travel aid interaction for visually impaired people. Master's thesis. The University of Manchester Institute of Science and Technology.

[Jacobson et al., tted] Jacobson, R, D., Kitchin, R. M., Golledge, R. G., and Blades, M. (submitted). Rethinking theories of blind people's spatial abilities. Journal of Visual Impairment. available at http://garnet.acns.fsu.edu/djacobso/haptic/nsf-und/contents.html.

[Jones et al., 2004] Jones, L. A., Nakamura, M., and Lockyer, B. (2004). Development of a tactile vest. In Proceedings of the 12th Symposium on Haptic Interfaces for Virtual Environment and Teleoperator Systems, pages 82-89, IEEE.

[Kaczmarek et al., 1991] Kaczmarek, K. A., Webster, J. G., y Rita, P. B., and Tompkins, W. J. (1991). Electrotactile and vibrotactile displays for sensory substitution systems. IEEE Transactions on Biomedical Engineering, 38(1): 1-16.

[Klatzky and S. J. Lederman, 2002] Klatzky, R. L. and S. J. Lederman, S. J. (2002). Handbook of psychology, chapter 4. Wiley.

[Landau and Jackendoff, 1993] Landau, B. and Jackendoff, R. (1993). What and where in spatial language and spatial cognition. Behavioral and Brain Sciences, 16:217-265.

[Lindeman and Cutler, 2003] Lindeman, R. W. and Cutler, J. R. (2003). Controller design for a wearable, near-field haptic display. In Proceedings of the 11th Symposium on Haptic Interfaces for Virtual Environment and Teleoperator Systems, pages 397-403. IEEE.

[Matthies et al., 1995] Matthies, L., Kelly, A., and Litwin, T. (1995). Obstacle detection for unmanned ground vehicles: A progress report. In International Symposium of Robotics Research, Munich, Germany.

[Meijer, 1992] Meijer, P. (1992). An experimental system for auditory image representations. IEEE Transactions on Biomedical Engineering, 39(2):12-121. updated info available at http://www.seeingwithsound.com.

[Molten et al., 1998] Molton, N., Se, S., Brady, J., Lee, D., and Probert, P.(1998). A stereo vision-based aid for the visually impaired. Image and Vision Computing, 16:251-263.

[Molten et al., 1999] Molton, N., Se, S., Brady, M., Lee, D., and Probert, P. (1999). Robotic sensing for the partially sighted. Journal of Robotics and Autonomous Systems, 26:185-201.

[Murray et al., 2003] Murray A., Klatzky, R., and Khosla, P. (2003). Psychophysical characterization and testbed validation of a wearable vibrotactile glove for telemanipulation. Presence: Teleoperators and Virtual Environments, 12:156-182.

[Nagel et al., 2005] Nagel, S. K., Carl, C., Kringe, T., Hartin, R., and Konig, P. (2005). Beyond sensory substitution—learning the sixth sense. Journal of Neural Engineering, 2:13-26.

[Pawluk, 1997] Pawluk, D. T. V. (1997). A Visocelastic Model of the Human Fingerpad and a Holistic Model of Human Touch. PhD thesis, Harvard University, Engineering Sciences, Harvard University, Cambridge, Mass., USA.

[Rukzio et al., 2005] Rukzio, E., Schmidt, A., and Kruger, A. (2005). The rotating compass: A novel interaction technique for mobile navigation. In CHI 2005, Portland, Oreg.

[Rupert, 2000] Rupert, A. (2000). An instrumentation solution for reducing spatial disorientation mishaps. IEEE Engineering in Medicine and Biology, pages 71-80.

[Sekuler and Blake, 2002] Sekuler, R. and Blake, R. (2002). Perception. McGraw Hill, 4th edition.

[Sherrick and Cholewiak, 1986] Sherrick, C. E. and Cholewiak, R. W. (1986), Handbook of perception and human performance, chapter 12—Cutaneous Sensitivity, pages 12.1-12.52. Wiley.

[Shoval et al., 2003] Shoval, S., Ulrich, I., and Borenstein, J. (2003). Navbelt and the guide cane. IEEE Robotics and Automation Magazine, 10(1):9-20.

[Summers, 1992] Summers, I. R. (1992). Practical Aspects of Audiology Tactile Aids for the Hearing Impaired. Whurr Publishers.

[Talukder et al., 2002] Talukder, A., Manduchi, R., Rankin, A., and Matthies, L. (2002). Fast and reliable obstacle detection and segmentation for cross-country navigation. In Proceedings of the 2002 IEEE Conference on Intelligent Vehicles Symposium, Versailles, France, IEEE.

[Tan, 1996] Tan, H. Z. (1996). Necessary Spatial Resolution for Realistic Tactile Feeling Display. PhD thesis, Massachusetts Institute of Technology, Dept. of Electrical Engineering and Computer Science.

[Tan et al., 2003] Tan, H. Z., Gray, R., Young, J. J., and Traylor, R. (2003). A haptic back display for attentional and directional cueing. Haptics-e, 3(1). http://www.haptics-e.org.

[Tan and Pentland, 2001] Tan, H. Z. and Pentland, A. (2001). Tactual Displays for Sensory Substitution and Wearable Computers, pages 579-598. Lawrence Erlbaum Associates.

[Toney et al., 2003] Toney, A., Dunne, L., Thomas, B. H., and Ashdown, S. P. (2003). A shoulder pad insert vibrotactile display. In 7th International Symposium on Wearable Computers, pages 35-44, White Plains, N.Y. IEEE.

[Tsukada and Yasumura, 2004] Tsukada, K. and Yasumura, M. (2004), Activebelt: Belt-type wearable tactile display for directional navigation. In Proc. of UbiComp 2004, pages 384-399.

[Vallbo and Johansson, 1984] Vallbo, A. and Johansson, R. (1984). Properties of cutaneous mechanreceptors in the human hand related to touch sensation. Human Neurobiology, 3:3-14.

[Wall et al. 2001] Wall, C., Weinberg, M., Schmidt, P., and Krebs, D. (2001). Balance prosthesis based on micromechanical sensors using vibrotactile feedback of tilt. IEEE Transactions of Biomedical Engineering, 48(10): 1153- 1161.

[Weisenberger, 1986] Weisenberger, J. M. (1986). Sensitivity to amplitude-modulated vibrotactile signals. Journal of Acoustical Society of America, 80(6):1707-1714.

[Weissgerber et al., 2004] Weissgerber, D., Bridgeman, B., and Pang, A. (2004). Vispad: A novel device for vibrotactile force feedback. In Proceedings of the 12th Symposium on Haptic Interfaces for Virtual Environment and Teleoperator Systems, pages 50-57. IEEE.

[Zelek, 2004] Zelek, J. (2004). Towards bayesian real-time optical flow. Elsevier Image and Vision Computing, 22:1051-1069.

[Zelek and Holbein, 2005] Zelek, J. and Holbein, M. (2005). Fpga haptics controller. In US Provisional Patent.

[Zelek and Levine, 2000] Zelek, J. S. and Levine, M. D. (2000), Local-global concurrent path planning and execution. IEEE Transactions on Systems, Many and Cybernetics Part B, 30(6):865-890.

We claim:

1. A tactile feedback navigation system comprising:
a first sensor operable to detect the global orientation of the user to produce a first output, said first sensor being an on-board sensor portable by a user, or an off-board sensor positioned distant from the user;
a sensor detector operable to detect geographic co-ordinate position (in terms of latitude and longitude) of the user to produce a second output, said geographic co-ordinate position being provided to indicate latitude and longitude, said sensor detector being an on-board sensor portable by a user, or an off-board sensor positioned distant from, the user;
a second sensor operable to detect 3-directional accelerations of the user to produce a third output, said second sensor being an on-board sensor portable by a user, or an off-board sensor positioned distant from the user, and any combination of the first output, the second output and the third output individually or collectively being sensor outputs;
a plurality of tactile actuators operable to provide directional information to a landmark and its inherent coordinate system, placed in the cardinal locations (North (N.), South (S.), West (W.), and East (E.)) aligned on a body part upon which a scale system is superimposed that repeats itself in degree ordinates; and each cardinal location is exactly separated by 90 degrees;
at least one tactile actuator operable to provide distance information to a landmark;
a wireless communication apparatus operable to communicate to an internet network via an external device;
an integrated power management and portable power source; and
a controller in communication with the sensors operable to receive and process at least one on-board sensor output and at least one off-board sensor output into an optimal accurate estimate of global position in terms of latitude and longitude and the position, and size of objects and terrain in the immediate environment, wherein the controller is operable to activate adjacent actuators in succession so as to indicate an intermediate point between two actuators by interpolation.

2. The tactile feedback navigation system as claimed in claim 1, wherein the entire system is a portable unit and worn by the user.

3. The tactile feedback navigation system as claimed in claim 1, wherein the entire system is a system that the user makes direct physical contact with.

4. The tactile feedback navigation system as claimed in claim 1, that acts as a tactile compass where no visual attention or its use is required by the user and information is purely provided in tactile form.

5. The tactile feedback navigation system as claimed in claim i, that acts as a global positioning system (GPS) where direction to a waypoint is purely provided in tactile form and no use of the visual sense is required by the user.

6. The tactile feedback navigation system as claimed in claim 1, wherein the controller fuses the positional information that the sensors provide and produces the signal for the actuation of the tactile units and generates the tactile unit(s) actuation signals.

7. The tactile feedback navigation system as claimed in claim 1, wherein the wireless communication apparatus can be used to provide a single or procedural sequence of waypoints; the wireless link can be used to provide additional sensor information, including a wireless link to any of GPS information or digital compass information, and said wireless link being operable from the external device, said external device being any of a cell phone, a personal digital assistant, or a computer, that connects to the internet network; the wireless link can provide geographic information system map information that can provide landmarks, obstacles or terrain characteristics; and the wireless link is used to provide positional information about the user to a remote monitor or caretaker.

8. The tactile feedback navigation system as claimed in claim 1, wherein the plurality of tactile actuators placed at cardinal locations providing directional information are attached to the body by a piece of clothing that hugs around a body part, wherein the clothing has the property of readily transmitting the tactile stimuli into the skin and minimizes lateral transmission along the piece of clothing.

9. The tactile feedback navigation system as claimed in claim 8, wherein the piece of clothing is selected from the group consisting of a belt, a wrist band, an arm band, a head band, a leg band and a chest belt.

10. The tactile feedback navigation system as claimed in claim 8, wherein an additional tactile motor not aligned or in close proximity to the plurality of directional tactile actuators is used to provide distance information to the user, and wherein the strength of actuator stimulation can be inversely correlated with the distance to the landmark/target and proportionally correlated with the distance to the landmark/target.

11. The tactile feedback navigation system as claimed in claim 5, wherein a queue of waypoints is provided to the controller in order to guide the user in tactile form to a final destination via the intermediate waypoints, and wherein annunciation can be provided to the user to indicate that the current intermediate waypoint has been reached and a new waypoint is the new current intermediate waypoint or an annunciation can be provided to the user to indicate that the final goal destination has been reached, and wherein annunciation can either be tactile, auditory or visual.

12. The tactile feedback navigation system as claimed in claim 8, wherein if the actual direction indicated by the sensor outputs is aligned with any of the cardinal directions (N., S., W., E.) indicated by 0 to 360 degrees and being a multiple of 90, only a single motor corresponding to that cardinal direction is activated and the other 3 directional motors are not activated. 0 degrees is defined as a geographical location which defines a coordinate frame of reference, and if the desired direction falls between 2 cardinal directions, then the 2 actuators associated with cardinal directions that are closest to that direction are activated in such a fashion that the human body interprets this information as falling between the 2 cardinal positions at an orientation that corresponds to the direction the desired geographical location, wherein the geographical location defining the coordinate frame of reference can be the Earth's magnetic North pole or a GPS defined waypoint, also referred to as the home or intermediate home position.

13. The tactile feedback navigation system as claimed in claim 12, wherein the actuator's intensity of vibration, frequency of vibration, waveform, pattern of activation, duration of activation, inter-stimulus interval or inter-activity is the variable controlled.

14. The tactile feedback navigation system as claimed in claim 1, where the human tactile perceptual interpolation ability is based on the cutaneous saltation effect.

15. The tactile feedback navigation system as claimed in claim 1, wherein the 1 or more tactile actuator providing distance information is related to the actuator(s)' intensity of vibration, frequency of vibration, waveform, pattern of activation, duration of activation, inter-stimulus interval or inter-activity as the variable controlled.

16. The tactile feedback navigation system as claimed in claim 1, wherein the system is applied as a wayfinding for people who are blind or as a homing device or localization device for people with Alzheimer's disease or dementia in general, or as a tool for locating the patient by a caretaker or care facility.

17. The tactile feedback navigation system as claimed in claim 1, wherein the function of the system is to guide the user to landmarks/targets which may be organized as a sequence in queue.

18. The tactile feedback navigation system as claimed in claim 1, wherein the entire system can function as an obstacle avoidance system, said obstacle avoidance system being operable to receive the estimate of global position providing latitude and longitude and the associated position and size of objects and terrain in the immediate environment, said position and size of objects and terrain being optionally provided by one or more sensors that are operable as a vision sensor, such objects and terrain defining possible obstacles, a different mode than the general mode of being directed to a goal.

19. The tactile feedback navigation system as claimed in claim 1, wherein the entire system can function as a system that can guide the user in a preferred path, or trajectory, whether it be to avoid obstacles or to maintain a straight line or follow a safe route to avoid injury, said system being operable to receive the estimate of the global position providing latitude and longitude and optionally the associated position and size of objects and terrain in the immediate environment that define possible obstacles, and the system being operable to process the received information to generate the preferred path or trajectory, said position and size of objects and terrain being optionally provided by one or more sensors that are operable as a vision sensor.

20. The tactile feedback navigation system as claimed in claim 8 wherein the belt is formed of neoprene.
